(19) United States
(12) Patent Application Publication
(10) Pub. No.: US 2024/0161069 A1
(43) Pub. Date: May 16, 2024

(54) SUPPORT CURRENCY MANAGEMENT SYSTEM AND COMMUNICATION TERMINAL

(71) Applicant: TESNOLOGY Inc., Tokyo (JP)

(72) Inventors: Katsuhiko KONDO, Tokyo (JP); Akihiko MATSUMURA, Tokyo (JP)

(21) Appl. No.: 18/422,244

(22) Filed: Jan. 25, 2024

Related U.S. Application Data
(63) Continuation of application No. PCT/JP2022/028756, filed on Jul. 26, 2022.

(30) Foreign Application Priority Data
Jul. 28, 2021 (JP) 2021-123227

(51) Int. Cl. G06Q 20/06; G06Q 20/12

(52) U.S. Cl. CPC G06Q 20/065; G06Q 20/12

(57) ABSTRACT

When a user purchases a product at a shop, the user entirely or partly pays a price in support currency issued by an operation company. The support currency is digital money, and is stored on a communication terminal. During a transaction, the communication terminal adds transaction information indicating transaction details to the support currency. The shop that has received the support currency can also use the support currency to purchase a product. At this time, a communication terminal used by the shop adds the transaction information indicating transaction details of a new transaction to the support currency.

### CROSS REFERENCE TO RELATED APPLICATIONS

This application is a continuation of International Patent Application No. PCT/JP2022/028756, having an international filing date of Jul. 26, 2022, which designated the United States, the entirety of which is incorporated herein by reference. Japanese Patent Application No. 2021-123227 filed on Jul. 28, 2021 is also incorporated herein by reference in its entirety.

### BACKGROUND OF THE INVENTION

“Money” is paid as compensation for goods and services. When A pays money to B, purchasing power of B is increased. The money transferred to B leads to new consumption of the goods and services. Money creates a network of trust based on reliance and results that “a counterparty accepts it as compensation for value”. Circulation of money based on the trust promotes economic activities such as development, proposal, production, and provision of the goods and services.

If many people save too much money to maintain their purchasing power, liquidity of money decreases, which leads to so-called “recession”. In such a case, it is common to implement monetary policies that stimulate the liquidity of money by lowering interest rates or supplying money to the market through government bonds or the like. However, it is not easy to assess actual economic effects of the money supplied to the market.

### BRIEF DESCRIPTION OF THE DRAWINGS

FIG. 1 is a schematic diagram of circulation of support currency.

FIG. 2 is a schematic diagram of a transmission method of the support currency.

FIG. 3 is a diagram illustrating a hardware configuration of a support currency management system.

FIG. 4 is a diagram illustrating a hardware configuration of a communication terminal.

FIG. 5 is a functional block diagram of the communication terminal.

FIG. 6 is a functional block diagram of an operation server.

FIG. 7 is a functional block diagram of an issuance server.

FIG. 8 is a sequence diagram illustrating a process of issuance and distribution of the support currency.

FIG. 9 is a screen diagram of a payment screen on the communication terminal.

FIG. 10 is a screen diagram of a support currency selection screen on the communication terminal.

FIG. 11 is a data structure diagram of transaction information.

FIG. 12 is a data structure diagram of the transaction information included in the support currency.

FIG. 13 is a schematic diagram of a transfer state of the support currency.

FIG. 14 is a schematic diagram of a method for selecting the support currency to be transmitted.

FIG. 15 is a sequence diagram illustrating a transaction process using the support currency.

FIG. 16 is a data structure diagram of accumulated commission information.

FIG. 17 is a data structure diagram of commission setting information.

FIG. 18 is a data structure diagram of commission adjustment information.

FIG. 19 is a data structure diagram of currency circulation information.

FIG. 20 is a data structure diagram of use condition information.

FIG. 21 is a data structure diagram of economic effect information.

FIG. 22 is a sequence diagram illustrating a processing process of distributing the support currency as an expression of gratitude for purchasing a product according to a modified example.

FIG. 23 is a sequence diagram illustrating a processing process of purchasing the support currency for a fee according to a modified example.

FIG. 24 is a conceptual diagram illustrating a method for circulating the support currency through website access according to a modified example.

FIG. 25 is a data structure diagram of transaction history information according to a modified example.

### DETAILED DESCRIPTION

The following disclosure provides many different embodiments, or examples, for implementing different features of the provided subject matter. These are, of course, merely examples and are not intended to be limiting. In addition, the disclosure may repeat reference numerals and/or letters in the various examples. This repetition is for the purpose of simplicity and clarity and does not in itself dictate a relationship between the various embodiments and/or configurations discussed. Further, when a first element is described as being “connected” or “coupled” to a second element, such description includes embodiments in which the first and second elements are directly connected or coupled to each other, and also includes embodiments in which the first and second elements are indirectly connected or coupled to each other with one or more other intervening elements in between.

According to one aspect of the invention, there is provided a support currency management system comprising at least one processor or circuit programed to:
record transaction information related to a transaction in association with support currency of digital currency that has been transferred, when the support currency is transferred from a first economic entity to a second economic entity due to the transaction between the first economic entity and the second economic entity; and
add the transaction information related to the transaction as the transaction information of the support currency each time the transaction using the support currency occurs.

According to one aspect of the invention, there is provided a communication terminal comprising at least one processor or circuit programed to:
perform data management of support currency of digital currency for each currency unit;
record transaction information related to a transaction using the support currency in association with the support currency used in the transaction for the each currency unit; and
transmit the support currency pertaining to the transaction to a communication terminal of a transaction counterpart of the transaction to transfer the support currency in the transaction.

Exemplary embodiments are described below. Note that the following exemplary embodiments do not in any way limit the scope of the content defined by the claims laid out herein. Note also that all of the elements described in the present embodiment should not necessarily be taken as essential elements.

### First Embodiment

In a present embodiment, an issuer X issues points as cash equivalents.

The points are hereinafter referred to as “support currency”. The support currency functions as so-called regional currency. The support currency is digital currency that can be transferred as compensation for transfer of goods and services.

The support currency is supported by legal currency. For example, one point of the support currency can be exchanged for 1 yen. A source of a fundamental value of the support currency is “trust in a country”, unlike virtual currency such as Bitcoin. The trust in the county ultimately depends on future tax revenues and national assets.

This description is made assuming the issuer X, an underwriter Y, shops A1 to An, and users (consumers) B1 to Bm.

Firstly, the issuer X issues 5 million points of the support currency. The issuer X (operation company) issues the support currency in response to an external instruction such as an issuance request from the underwriter Y.

The underwriter Y purchases the 5 million points of the support currency from the issuer X for 5 million yen. The underwriter Y is assumed to be a government agency, a local public organization (also referred to as a “local government”), a financial institution, or the like. In this description, the underwriter Y is assumed to be a local public organization that desires to vitalize the economy in a region Z (municipality).

The support currency is electronic currency.

Each point of the support currency is identified by a currency ID.

The support currency is an object (electronic content) packaged with the currency ID and transaction information (described later).

The underwriter Y distributes the support currency to the shops A1 to An in the region.

The underwriter Y may transfer the support currency for free or for a fee. In this description, it is assumed to be transfer for free.

Assume that the underwriter Y transfers 50,000 points of the support currency out of the 5 million points to the shop A1 for free. For the shop A1, this means that a subsidy equivalent to 50,000 yen is provided from the underwriter Y.

When the underwriter Y transfers the 50,000 points to the shop A1, the underwriter Y inputs transaction information D1 including a “provider (Y)”, a “recipient (A1)”, a “provided date and time”, and a “provided reason (e.g., shop support)” to the support currency.

For example, the transaction information D1 described above is given to one point of the support currency whose currency ID is 1 (hereinafter referred to as a “support currency (1)”). When the currency IDs of the 50,000 points of the support currency are “1 to 50000”, the underwriter Y gives the transaction information D1 to each of the support currency (1) to the support currency (50000).

The shop A1 receives the 50,000 points of the support currency (objects) with the transaction information D1.

At this time, the issuer X receives part of the support currency (50,000 points) to be transferred, such as 1%, as a commission. In the above case, the underwriter Y pays 500 yen that is 1% of the 50,000 points of the support currency to the issuer X.

The issuer X may receive the commission from an account of a transferor or an account of a transferee.

An application (hereinafter referred to as a “support tool”) for support currency control, which has been introduced beforehand by the underwriter Y, adds the transaction information D1 to the support currency (objects) and executes settlement processing for 500 yen to be paid to the issuer X when transmitting the 50,000 points of the support currency to the shop A1.

The issuer X receives 500 yen as the commission from a bank account of the underwriter Y.

Assume that a user B1 eats at the shop A1.

Also, assume that the user B1 answers a questionnaire of the shop A1 at this time.

The questionnaire gives various types of information on the user B1 to the shop A1, such as, “I am allergic to buckwheat”, “The buckwheat noodles were good”, or “I like buckwheat noodles”.

The shop A1 transfers 50 points of the support currency to the user B1 as an expression of gratitude for giving the information.

When the shop A1 transfers the 50 points of the support currency to the user B1, the support tool of the shop A1 inputs transaction information D2 including the “provider (A1)”, the “recipient (B1)”, the “provided date and time”, and the “provided reason (e.g., answering the questionnaire)” to the support currency. In this example, the shop A1 gives the transaction information D2 to each of the support currency (1) to the support currency (50).

The user B1 receives the 50 points of the support currency with the transaction information D1 and D2 with an information terminal such as a smartphone.

The support tool introduced to the shops and the users does not display the transaction information D1 or D2 given to the support currency on the terminal.

The issuer X collects the commission corresponding to 1% of the support currency (50 points) to be transferred from the shop A1.

One percent of the 50 points is 0.5 yen. When the commission is less than 1 yen (minimum withdrawal amount), the issuer X collects the commissions in a lump sum when the commissions of the shop A1 exceed 1 yen. The minimum withdrawal amount can be set arbitrarily.

The issuer X may receive the commission from the user B1 (transferee) instead of the shop A1 (transferor). Alternatively, the issuer X may receive the commission from both of the shop A1 and the user B1.

Assume that the user B1 receives a personal service from another user B2.

For example, the user B2 carries baggage for the user B1.

At this time, the user B1 transfers 500 points of the support currency to the user B2 as an expression of gratitude. Assume that 20 points (the support currency (1) to the support currency (20)) of the 500 points of the support currency derive from the support currency transferred from the shop A1 to the user B1.

When the support currency is transferred from the user B1 to the user B2, the information terminal (support tool) of the user B1 gives transaction information D3 due to the transfer to the support currency.

The support currency (1) to the support currency (20) are associated with the transaction information D1, D2 and D3.

The issuer X collects part of the support currency to be transferred from the user B1 as the commission.

Assume that the user B2 eats at the shop A1.

The user B2 can partly or entirely pay the cost using the support currency.

Here, assume that the user B2 pays 200 yen using 200 points of the support currency.

At this time, the support currency is transmitted from an information terminal of the user B2 to a shop terminal of the shop A1.

The support tool installed on the information terminal of the user B2 adds new transaction information D4 to the 200 points of the support currency.

Assume that 10 points (the support currency (1) to the support currency (10)) out of the 200 points of the transferred support currency are the support currency transferred from the shop A1 to the user B1, and also from the user B1 to the user B2.

In this case, the support currency (1) to the support currency (10) are associated with the transaction information D1, D2, D3, and D4.

The issuer X collects part of the support currency to be transferred from the user B2 as the commission.

As described above, the support currency issued by the issuer X circulates in an order of the shop A1, the user B1, the user B2, and the shop A1 from the underwriter Y.

More particularly, of 50,000 points of the support currency (the support currency (1) to the support currency (50000)) issued by the issuer X, 5,000 points of the support currency (the support currency (1) to the support currency (5000)) are transferred from the issuer X to the underwriter Y, and 500 points of the support currency (the support currency (1) to the support currency (500)) thereof are transferred from the underwriter Y to the shop A1.

The support currency (1) to the support currency (50) included in the support currency (1) to the support currency (5000) are transferred from the shop A1 to the user B1. The support currency (1) to the support currency (20) included therein are also transferred from the user B1 to the user B2. The support currency (1) to the support currency (10) included therein are also transferred from the user B2 to the shop A1.

In the circulation process described above, the 10 points of the support currency (the support currency (1) to the support currency (10)) that have undergone four transactions are given the transaction information D1 to D4.

The user B1 can earn the 50 points of the support currency by eating at the shop A1 and answering the questionnaire.

The support currency can be used in the same way as cash at the shops A1 to An in the region Z. Accordingly, the user B1 can make a profit by giving the information to the shop A1.

The user B1 has also used the support currency as the expression of gratitude for a kindness of the user B2. In other words, the user B1 has tipped the user B2 using the support currency.

When the user B2 is not a business entity but a person close to the user B1, the user B1 tends to hesitate to pay money (cash) to thank the user B2.

Generally speaking, people close to each other tend to feel resistance to transaction of money between them. As human feelings, the closer the relationship is, the less appropriate it is to involve money in the relationship.

For this reason, recipients receiving favors often express their gratitude with “words (thank you)” or “gifts (goods)”.

Although the support currency in the present embodiment is a cash equivalent, the user B1 has received the support currency as a gift in return for a simple act of “answering the questionnaire”. For this reason, when the user B1 gives the support currency to the user B2 to thank him/her, neither the user B1 nor the user B2 feels as much resistance as handing over money.

When the user B1 transfers the 500 points of the support currency to the user B2, the user B1 pays 5 yen, which corresponds to 1% of the 500 points, to the issuer X.

The user B1 can give a value worth 500 yen to the user B2 with an actual economic burden of 5 yen. The user B1 can casually thank the user B2 with the support currency that the user B1 has gained almost for free. In addition, since the user B2 knows that the support currency has not been gained by labor of the user B1, the user B2 can casually accept the support currency.

The user B2 can gradually earn the support currency by daily kind acts.

The user B2 can receive the service of the meal at the shop A1 by earning the support currency.

The shop A1 can freely utilize the support currency provided for free.

In the example described above, the shop A1 can acquire the useful information related to consumption behavior of a customer by giving the support currency to the user B1. The shop A1 can also attracts the user B2 by making the support currency available.

The shop A1 can improve efficiency and vitalize the business by utilizing the support currency.

The underwriter Y (local government) can circulate the support currency in the region Z with a budget of 5 million yen. The underwriter Y can vitalize the shops A1 to An in the region Z by means of the support currency. The underwriter Y can expect an increase in tax revenues by vitalizing the region Z. In addition, since residents in the region Z try as much as possible to consume the regional currency in the region Z where the regional currency is accepted, the support currency can contribute to vitalization of the regional economy in this aspect as well.

The underwriter Y can also use the support currency when the underwriter Y desires to attract foreign tourists to the region Z. The underwriter Y may distribute the support currency to the foreign tourists. The foreigners who have received the distributed support currency may find sightseeing in the region Z attractive, and spend cash money as well as the support currency in the region Z.

The issuer X can earn commission income due to circulation of the support currency.

The issuer X and the underwriter Y can refer to the transaction information given to the support currency to know how the support currency circulates (circulation speed, circulation routes, reasons for completing the transactions). This makes it easier to appropriately form policies required for vitalizing the regional economy. For example, the issuer X or the underwriter Y can analyze which are effective shops to distribute the support currency or to what extent the support currency spreads among the residents in the region Z.

The support currency starts circulating after it is transferred for free by the underwriter Y in the first place. The circulation of the support currency is further promoted when a number of shops (business entities) that can accept the regional currency or a number of users (consumers) increases.

In addition, the fact that the support currency works as a tool to express gratitude for a small kindness without resistance contributes to the promotion of the circulation of the support currency. For example, a user B3 may give the support currency to a shop A2 as a tip when the user B3 is satisfied with the service of the shop A2.

The support currency may be a depreciated currency. For example, when the user B3 transfers 501 points of the support currency to a user B4, the user B4 may receive 500 points of the support currency and 1 point of the support currency may be depreciated.

Since the support currency is depreciated by the transaction, the issuer X is to reissue the support currency in due time. By repeating the issuance and depreciation in this manner, the circulation speed of the support currency can be further enhanced.

The support currency may be depreciated at regular intervals. For example, the support currency may be automatically depreciated by 1% per day. In this case, since the users suffer a loss if the users save up the support currency, the users try to use the support currency for consumption activities as much as possible. With such a control method as well, the circulation of the support currency can be further promoted.

The value of money increases through transactions. Similar to the money (cash), the value of the support currency increases through the circulation in the region Z. The circulation of the support currency, separately from money or with money, can result in an actual increase in GDP. Since the GDP increases as the circulation speed of money increases, the substantial GDP is a sum of the GDP of money and the GDP of the support currency.

The support currency can also be used in logistics. In this case, a logistics company becomes the underwriter Y and purchases the support currency from the issuer X.

Assume that a user B5 (sender) sends a luggage to a user B6 (recipient).

The user B6 (recipient) specifies a date and time that the user B6 can receive the luggage.

A delivery person C1 designated by the logistics company transports the luggage to a house of the user B6 (recipient) on the specified date and time.

The delivery person C1 receives the support currency from the logistics company if the delivery person C1 delivers the luggage on the specified date and time. The user B6 (recipient) also receives the support currency from the logistics company if the user B6 receives the luggage on the specified date and time.

On the contrary, assume that the delivery person C1 cannot deliver the luggage due to absence of the user B6 (recipient) on the specified date and time.

In this case as well, the delivery person C1 can receive the support currency if the delivery person C1 arrives at the house of the user B6 on the specified date and time. On the other hand, the user B6 who is absent cannot receive the support currency.

The delivery person C1 can receive the support currency for his/her labor even if the delivery person C1 has to deliver the luggage again. Accordingly, even if a labor of redelivery occurs, the delivery person C1 can receive compensation in the support currency.

The user B6 (recipient) can receive the support currency from the logistics company if the user B6 stays at home on the specified date and time. However, if the redelivery occurs, the user B6 cannot receive the support currency. Such a system can bring the user B6 (recipient) to stay at home so as to receive the luggage for sure on the specified date and time.

The transaction information may be given to the support currency itself, or a “currency ID” and a “transaction ID” may be given to the support currency and the transaction information may be managed in association with this information.

For example, when the user B1 transfers the support currency to the user B2, the communication terminal of the user B1 generates the transaction ID. In order to avoid generating the same transaction IDs, the transaction ID may include one-time information such as the time.

The communication terminal (B1) notifies a server of the issuer X of the transaction ID and the transaction information when transferring the support currency.

The server registers the transaction ID and the transaction information in correspondence.

The communication terminal (B1) deletes the transaction information from a local memory. That is, the support currency may include only the “currency ID” and the “transaction ID”.

The issuer can acquire the transaction information of the support currency by confirming the currency ID and the transaction ID given to the support currency.

The support currency may be given as compensation for information.

Assume that the user B1 wants information such as a good restaurant for a vegan in the region Z.

The user B1 solicits the information. Assume that another user gives the information in response. The user B1 may pay the support currency as an expression of gratitude to the other user who has given the information.

The transaction of the support currency can be performed via a web browser or a known two-dimensional code.

The transaction between the users may be transferring or lending goods or providing services.

A1. When the transaction is made between a first user and a second user, a first communication terminal of the first user may transfer the support currency to a second communication terminal of the second user and associate a transaction type with the support currency.

A2. The first communication terminal may transmit the support currency to the second communication terminal directly by short-range wireless communication or via a relaying apparatus such as a gateway server.

A3. When the transaction is made, part of the support currency is paid to the issuer of the support currency.

The following describes functions and a configuration of a support currency management system 200 according to the present embodiment in detail.

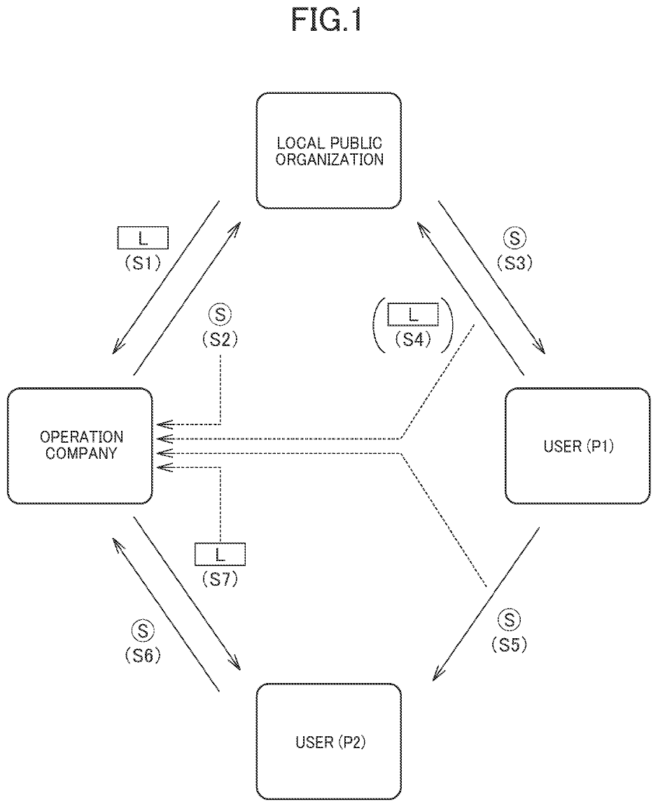

FIG. 1 is a schematic diagram of the circulation of the support currency.

Firstly, a process of the circulation of the support currency is described assuming four parties including a local public organization (underwriter), an operation company (issuer), a user (P1), and a user (P2). Here, the “user” is described as an economic entity who makes transactions using the support currency, and means both an individual and a shop (business entity).

In the present embodiment, two types of currencies including a “basic currency” and the “support currency” circulate between the users. The basic currency may be the legal currency or any other known existing currency such as gold, silver, or cryptocurrency. The support currency is original digital currency issued by the operation company upon request from the underwriter such as a local public organization, a government, a non-profit organization (NGO), or a company. In the present embodiment, the local public organization is an entity (issuance requesting entity) that requests the issuance of the support currency. The support currency is issued for the purpose of promoting the circulation of the basic currency for regional economic promotion.

A unit of the support currency is called a “point (pt)”. One (pt) of the support currency is equivalent to 1 (yen). The operation company issues the support currency in response to the issuance request from the local public organization, and manages the support currency. The operation company is an entity (issuance executing entity) that issues the support currency based on the request from the local public organization.

Firstly, the local public organization pays the legal currency (basic currency L) to the operation company (S1), and in return, the operation company issues support currency S for the local public organization (S2). At this time, the operation company collects a small commission from the local public organization. The local public organization transfers the received support currency to the user (P1) (S3). The operation company collects a small commission from the user (P1) (transferee). The user (P1) may purchase the support currency by paying the basic currency to the local public organization (S4). Alternatively, the local public organization may transfer the support currency to the user (P1) for free. The following description is made assuming the transfer for free.

The user (P2) provides goods or services to the user (P1). In the following description, a “product” is a concept including the “services” unless otherwise specified. Assume that the user (P1) pays the support currency to the user (P2) for a price of a product (S5). The operation company collects the commission on this transaction from the user (P2) who is the transferee.

The user (P2) can request the operation company to exchange the support currency and the basic currency. The user (P2) pays the support currency to the operation company (S6), and the operation company pays the basic currency to the user (P2) (S7). The operation company also collects part of the basic currency from the user (P2) as the commission.

As described above, the support currency issued by two parties including the local public organization and the operation company circulates among a large number of users.

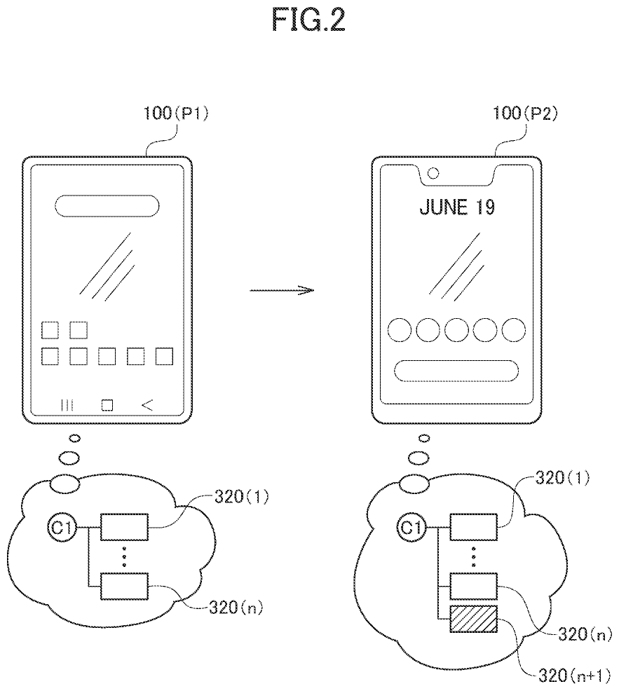

FIG. 2 is a schematic diagram of a transmission method of the support currency.

The user is identified by a user ID. In the following description, the user (P1) means a user whose user ID is P1. Here, the description is made assuming that the user (P1) transmits (transfers) the support currency to the user (P2).

Firstly, each 1 (pt) (equivalent to 1 yen) of the support currency is identified by the currency ID. A communication terminal 100 (hereinafter expressed as a “communication terminal (P1)”) of the user (P1) stores a unit of the support currency whose currency ID is C1 (hereinafter expressed as a “support currency (C1)”). A substance of the unit of the support currency is a dataset including data indicating the currency ID which is C1 and one or more pieces of the transaction information 320. The support currency (C1) shown in FIG. 2 is associated with n pieces of the transaction information 320(1) to 320(n). Details of the transaction information 320 will be described later.

The currency ID may be numbers or a combination of numbers and characters. For example, the currency ID may include character information indicating a support currency type (described later), numeral information indicating an issuance date and time of the support currency or a serial number, or the like. Regardless of a format, the currency ID may be any kind of information if it can uniquely identify 1 (pt), or one unit, of the support currency.

The communication terminal 100 (P1) on a transferor side and a communication terminal 100 (P2) on a transferee side include a support tool called DI engine installed beforehand. The DI engine in the present embodiment includes an integrated circuit (IC) chip having a communication function and lightweight software.

The support tool of the communication terminal 100 (P1) adds transaction information 320 (n+1) indicating transaction details of the transaction with the user (P2) to the support currency (C1) and transmits the support currency (C1) to the communication terminal 100 (P2). After transmitting the support currency (C1), the support tool of the communication terminal 100 (P1) deletes the support currency (C1) from a local storage of the communication terminal 100 (P1). As a result, the user (P1) loses the 1 (pt) of the support currency (C1).

On the other hand, the support tool of the communication terminal 100 (P2) on the transferee side records the support currency (C1) in a local storage of the communication terminal 100 (P2) upon receipt of the support currency (C1). As a result, the user (P2) acquires the 1 (pt) of the support currency (C1).

As described above, when the support currency is transferred between the users, the support currency (digital data) is deleted on the transferor side and the support currency is recorded on the transferee side. In addition, the transaction information 320 is added to the support currency every time the transaction occurs.

More particularly, the support tool of the communication terminal 100 (P1) encrypts and stores the support currency in the local storage. The communication terminal 100 (P1) transmits the support currency in an encrypted state. The support tool of the communication terminal 100 (P2) decrypts the received support currency to confirm authenticity of the support currency, and encrypts the support currency again to store it in the local storage of the communication terminal (P2). Encryption and decryption of the support currency are automatically performed by the support tool. The users cannot engage in the encryption and decryption of the support currency.

The support currency can be paid from the user (P1) to the user (P2) when the user (P1) gives an expression of gratitude for a kindness of the user (P2), when the user (P1) gives a gift to the user (P2), or the like, in addition to when the user (P1) purchases a product from the user (P2). The transaction information 320 is added to the support currency every time the transaction is made.

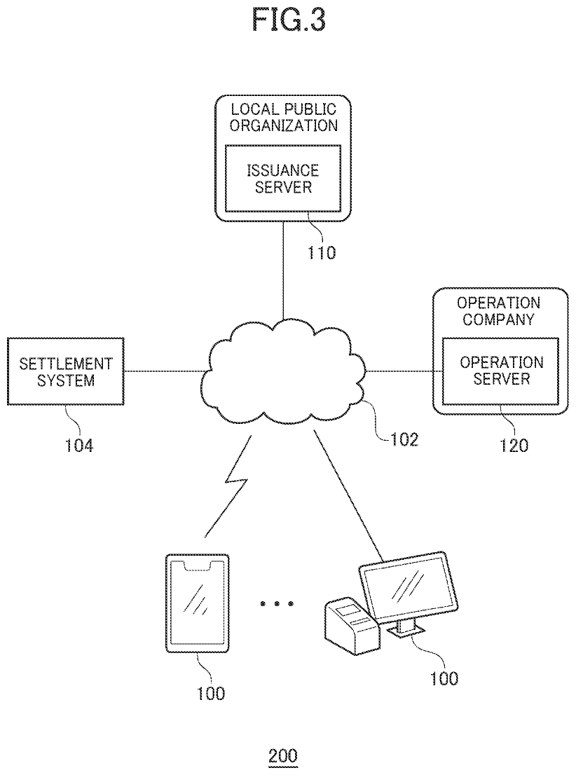

FIG. 3 is a hardware configuration diagram of the support currency management system 200.

In the support currency management system 200, an issuance server 110 (issuance system) managed by the local public organization, an operation server 120 (operation system) managed by the operation company, a settlement system 104, and a plurality of communication terminals 100 are mutually connected via an Internet 102.

The local government (issuance server 110) requests the operation company (operation server 120) to issue the support currency. The issuance request includes a use condition (described later) and an issuance amount of the support currency. The operation server 120 issues the support currency according to the request. The local government distributes the issued support currency to parts of the plurality of the communication terminals 100 or specific communication terminals 100. The settlement system 104 is a system managed by a financial institution.

The communication terminal 100 is assumed to be a smartphone, a laptop PC, a point of sales (POS) terminal, or the like. The individuals or the business entities mutually exchange the support currency using the communication terminals 100.

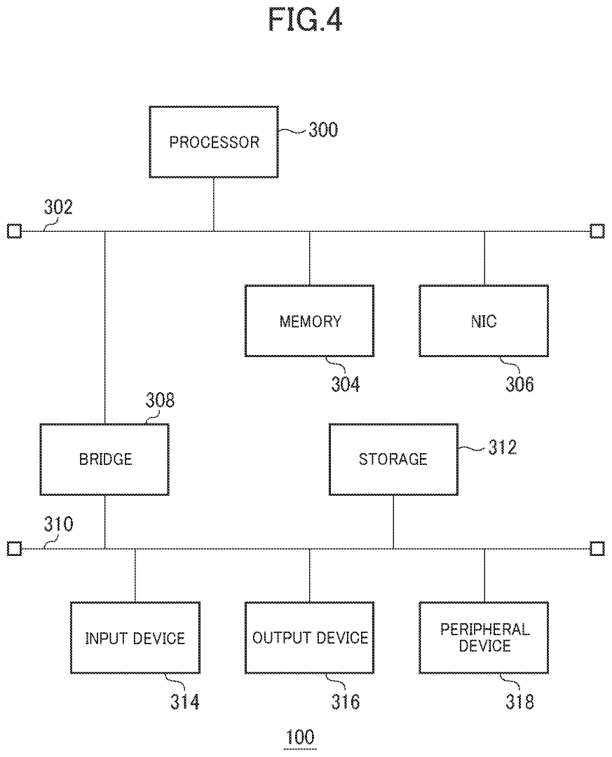

FIG. 4 is a hardware configuration diagram of the communication terminal 100.

The communication terminal 100 includes a storage 312 as nonvolatile memory for storing computer programs, a memory 304 as volatile memory for deploying the programs and data, a register, an arithmetic unit, an instruction decoder, or the like. The communication terminal 100 also includes a processor 300 (central processing unit: CPU) that reads the programs from the memory 304 and executes them, or the like. The processor 300 is connected to a first bus 302 that is relatively high speed. The first bus 302 is connected to the memory 304 and a network interface card (NIC). The first bus 302 may be further connected to other devices such as a graphics processing unit (GPU) or the like.

The first bus 302 is connected to a second bus 310 that is relatively low speed via a bridge 308. The second bus 310 is connected to the storage 312 and an output device 316 such as a monitor or a speaker. The second bus 310 may be connected to an input device 314 such as a mouse or a keyboard, and a peripheral device 318 such as a printer.

Hardware configurations of the issuance server 110 and the operation server 120 are basically similar to the hardware configuration of the communication terminal.

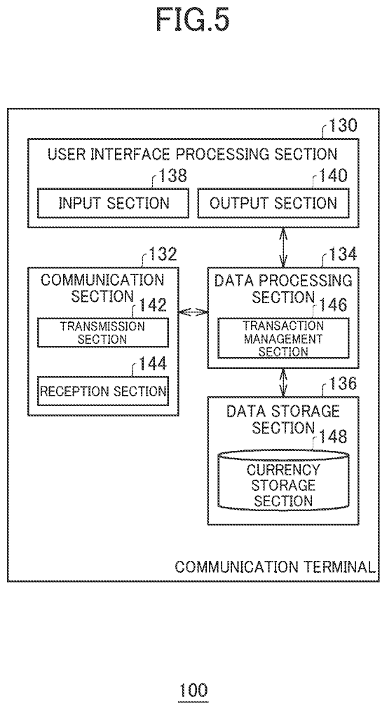

FIG. 5 is a functional block diagram of the communication terminal 100.

Components of the communication terminal 100 are implemented by hardware including arithmetic units such as a CPU and various co-processors, storage devices such as a memory and a storage, and wired or wireless communication lines connecting these elements, and software that is stored in the storage devices and supplies processing instructions to the arithmetic units. The computer programs may include a device driver, an operating system, various application programs located on an upper layer of the device driver and the operating system, and a library for providing common functions to these programs.

The various functions shown in FIG. 5 are implemented by a main body of the communication terminal 100 and the DI engine (support tool) installed on the communication terminal 100.

Each block described below does not indicate a functional unit block, but indicates a hardware unit configuration. This applies to the issuance server 110 and the operation server 120 as well.

The communication terminal 100 includes a user interface processing section 130, a communication section 132, a data processing section 134, and a data storage section 136.

The user interface processing section 130 performs processing related to a user interface including receiving operation from the user via the input device, displaying images, and outputting sounds. The communication section 132 performs communication processing for communicating with other communication terminals 100 or the like. The data storage section 136 stores various data. The data processing section 134 executes various types of processing based on input from the user interface processing section 130, received data via the communication section 132, and data stored in the data storage section 136. The data processing section 134 also functions as an interface for the communication section 132, the user interface processing section 130, and the data storage section 136.

The user interface processing section 130 includes an input section 138 and an output section 140.

The input section 138 receives various types of input from the user. The output section 140 outputs various types of information to the user.

The communication section 132 includes a transmission section 142 and a reception section 144.

The transmission section 142 transmits various data to external devices. The reception section 144 receives various data from the external devices.

The data processing section 134 includes a transaction management section 146. The transaction management section 146 adds the transaction information 320 to the support currency when transmitting the support currency to other communication terminals 100. The transaction management section 146 executes encryption and decryption of the support currency.

The data storage section 136 includes a currency storage section 148. The currency storage section 148 manages digital data corresponding to the support currency. The support currency is stored in the currency storage section 148 in the encrypted state.

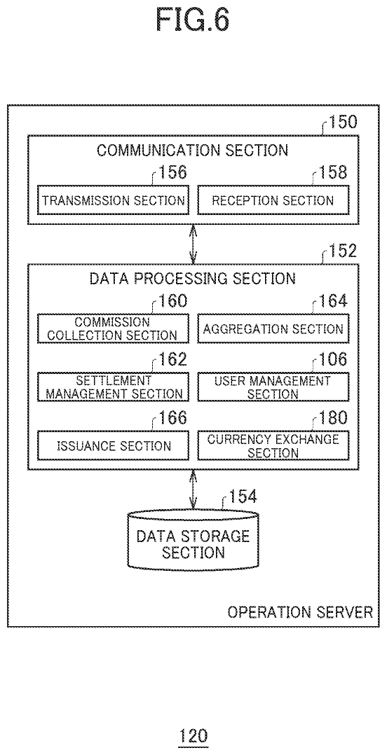

FIG. 6 is a functional block diagram of the operation server 120.

The operation server 120 is a server managed by the operation company. The operation server 120 includes a communication section 150, a data processing section 152, and a data storage section 154. The communication section 150 performs communication processing for communicating with the external devices such as the communication terminals 100. The data storage section 154 stores various types of information. The data processing section 152 executes various types of processing based on data acquired by the communication section 150 and data stored in the data storage section 154. The data processing section 152 also functions as an interface for the communication section 150 and the data storage section 154.

The communication section 150 includes a transmission section 156 and a reception section 158.

The transmission section 156 transmits various data to the external devices. The reception section 158 receives various data from the external devices.

The data processing section 152 includes a currency exchange section 180, a commission collection section 160, a settlement management section 162, an aggregation section 164, a user management section 106, and an issuance section 166.

The user management section 106 gives a user ID to a user when a user registration request is received from a communication terminal 100 having the support tool installed on it. For user registration, the user management section 106 registers attribute information such as an address, gender, an occupation, or a bank account number of the user in association with the user ID as user information. The operation server 120 shares the user information with the issuance server 110.

The commission collection section 160 collects the commission from the bank account of the user on a receiving side of the support currency when the transaction using the support currency occurs. As an alternative example, the commission collection section 160 may collect the commission from the bank account of the user on a paying side of the support currency. The settlement management section 162 accepts the basic currency from the local government, and executes the settlement for issuing the support currency. The settlement management section 162 withdraws an amount (basic currency) of the support currency from a bank account of the local government, and manages it as a deposit (hereinafter referred to as “operation deposit currency”). The aggregation section 164 aggregates the transaction information 320 of the support currency and analyzes economic effects. The issuance section 166 issues the support currency. The issuance section 166 also registers the use condition (described later) of the support currency in the data storage section 154 when issuing the support currency. The currency exchange section 180 exchanges the basic currency and the support currency.

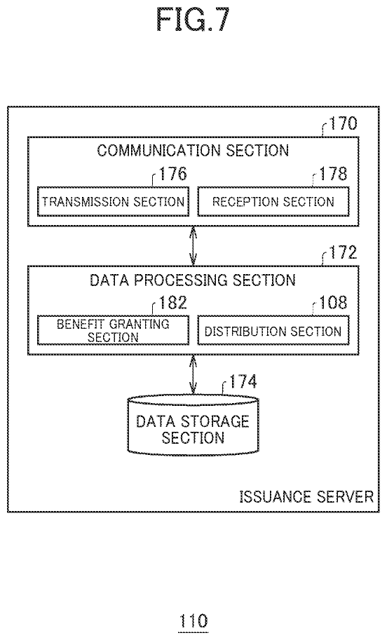

FIG. 7 is a functional block diagram of the issuance server 110.

The issuance server 110 is a server managed by the local government. The issuance server 110 includes a communication section 170, a data processing section 172, and a data storage section 174. The communication section 170 performs communication processing for communicating with the external devices such as the communication terminals 100. The data storage section 174 stores various types of information. The data processing section 172 executes various types of processing based on data acquired by the communication section 170 and data stored in the data storage section 174. The data processing section 172 also functions as an interface for the communication section 170 and the data storage section 174.

The communication section 170 includes a transmission section 176 and a reception section 178.

The transmission section 176 transmits various data to the external devices. The reception section 178 receives various data from the external devices.

The data processing section 172 includes a benefit granting section 182 and a distribution section 108.

When a predetermined benefit condition is met in a transaction, the benefit granting section 182 provides a benefit to a transactor. The distribution section 108 distributes the support currency to the communication terminals 100.

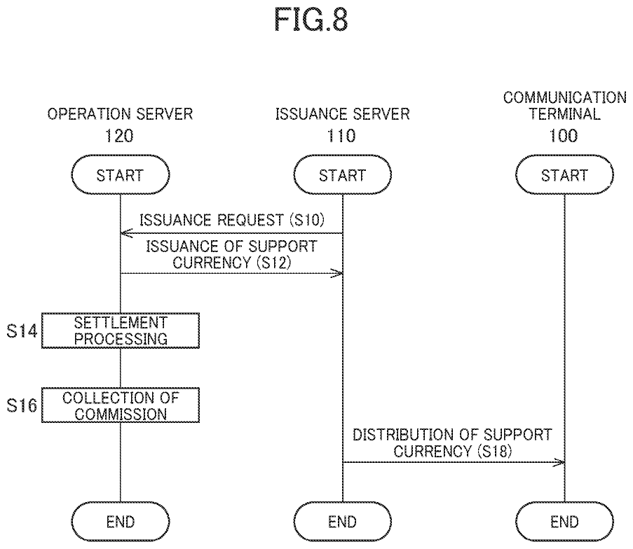

FIG. 8 is a sequence diagram illustrating a process of issuance and distribution of the support currency.

Firstly, the issuance server 110 of the local government transmits an issuance request of the support currency to the operation server 120 of the operation company (S10). The issuance request includes the issuance amount and the use condition. At this time, the local government pays the basic currency (legal currency) equivalent to the issuance amount to the operation company. For example, when 10 billion (pts) of the support currency is issued, the local government pays 10 billion (yen) to the operation company.

The issuance section 166 of the operation server 120 issues the specified amount of the support currency (S12). At this time, the issuance section 166 sets the currency ID to the support currency. As described above, the currency ID may be any kind of information if it can identify every 1 (pt) unit of the currency. The settlement management section 162 instructs the settlement system 104 to settle the payment in the basic currency from the bank account of the local government (S14). Due to this settlement processing, the basic currency is transferred from the local government to the operation company. The operation company manages a fund (basic currency) received from the local government as the operation deposit currency. On the other hand, the local government manages the support currency received from the operation company as “issued deposit currency”. The commission collection section 160 collects the commission for issuing the support currency (S16). The commission collection section 160 may collect the commission together with an amount to be transferred by adding the commission to the amount to be transferred.

The distribution section 108 of the issuance server 110 distributes the issued deposit currency (support currency) to a plurality of communication terminals 100 for free. For example, when the issuance server 110 has the 10 billion (pts) of the issued deposit currency, the distribution section 108 may distribute 1,000 (pts) of the support currency to every resident. Accordingly, the user receives the 1,000 (pts) of the support currency from the local government.

The support currency may be issued such that the support currency is transmitted to the communication terminals 100 directly from the operation server 120 without being transferred through the issuance server 110. That is, the issuance server 110 may notify the operation server 120 of the issuance amount and distribution destinations of the support currency, and the operation server 120 may transmit the support currency to the communication terminals 100 according to the notification.

A distribution target of the support currency may be set arbitrarily by a policymaker of the local government. For example, the policymaker may limit the distribution destinations of the newly issued support currency to shops in the region Z. When the users (shops) register as members with the support currency management system 200, the users register attribute information such as a size of the shop, a type of business, or a location as the user information in the operation server 120. The distribution section 108 of the issuance server 110 refers to the user information shared with the operation server 120, and transmits the support currency to addresses of the users of the distribution targets.

Alternatively, the support currency may be issued for visitors to the region Z as the targets. Assume that a user (P3) is a user who lives outside the region Z. When the user (P3) visits the region Z, a communication terminal 100 (P3) transmits positional information and the user ID to the issuance server 110. The distribution section 108 of the issuance server 110 detects that the user (P3) is a user who visits the region Z from another region based on the user ID and the positional information, and transmits the support currency to the communication terminal 100 (P3) as an expression of gratitude for his/her visit. With such a control method, motivation to visit the region Z from other regions can be evoked. In addition, the support currency received by the visitors promotes consumption activities in the region Z.

A plurality of local governments can issue original support currencies. One local government can also issue a plurality of types of the support currencies. Each of the types of the support currencies is identified by a type ID. The following description is made mainly assuming a support currency (type ID=K1) issued in Odawara city. The support currency issued in Odawara city is expressed as a “support currency (K1<Odawara>)”, or a “support currency (K1)” which omits an issuance target region. Odawara city is a sister city of Nikko city. The use condition of the support currency (K1<Odawara>) is set to allow use in Nikko city as well as Odawara city. Similarly, a support currency (type ID=K4) (expressed as a “support currency (K4<Nikko>), or a “support currency (K4)” as described above) issued in Nikko city can be used in Odawara city as well as Nikko city.

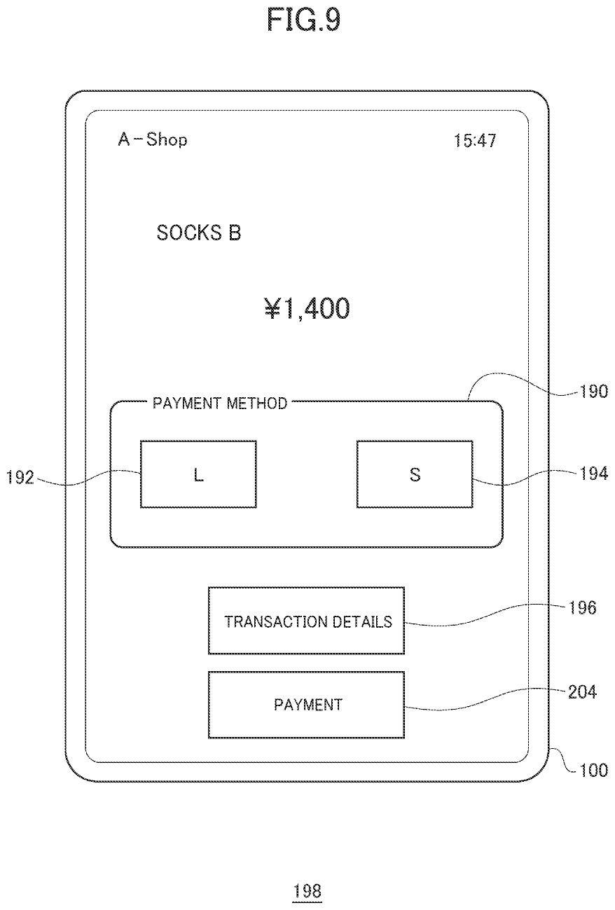

FIG. 9 is a screen diagram illustrating a payment screen 198 on the communication terminal 100 (P1) owned by the user (P1).

Here, the description is made assuming that the user (P1) purchases “socks B” at a shop (user (P4)) named “A-Shop”. A communication terminal 100 (P4) installed at the shop (P4) is assumed to be a POS terminal. At checkout of the product, the communication terminal 100 (P4) transmits information indicating transaction details such as a product name or a payment amount to the communication terminal 100 (P1). The output section 140 of the communication terminal 100 (P1) displays the payment screen 198. The user (P1) confirms the product to purchase on the payment screen 198.

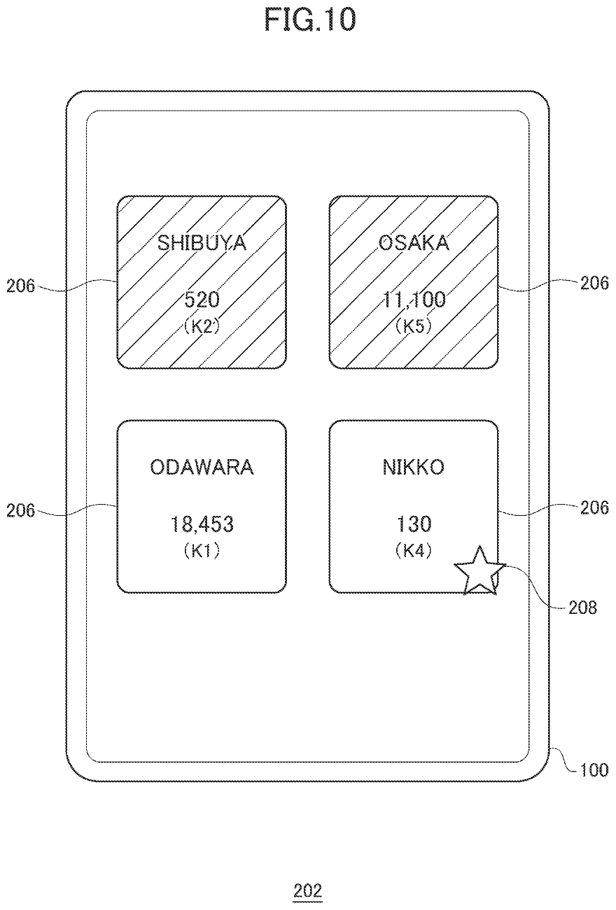

The user (P1) pays the price of the product in the basic currency or the support currency. The user may pay in both the basic currency and the support currency. A basic currency button 192 and a support currency button 194 are displayed in a currency selection area 190. The user (P1) touches the basic currency button 192 when paying in the basic currency, and inputs the payment amount. The user (P1) touches the support currency button 194 when paying in the support currency, and inputs the payment amount (number of points). For example, when the “socks B” costs 1,400 yen, the user (P1) may pay 1,000 yen in the basic currency and remaining 400 (yen) in the support currency. A payment method using the basic currency is the same as a payment method using a credit card or electronic money. When the user (P1) touches the support currency button 194, a support currency selection screen 202 shown in next FIG. 10 is displayed (described later).

As described above, the communication terminal 100 (P4) transmits the information indicating the transaction details to the communication terminal 100 (P1). When the user (P1) touches a transaction detail button 196, the output section 140 displays the transaction details. The user (P1) confirms the transaction details on the display screen (not illustrated) of the transaction details, and can correct them if necessary. At this time, the user (P1) can input a transaction reason. The transaction reason can include “product purchase”, “present”, “reward for a kindness” “repayment of a debt”, “loan”, or the like.

After determining allotment of the basic currency and the support currency for the payment of the price of the product, the user (P1) touches a payment button 204. When the payment in the support currency is included, the transaction information 320 is added to the support currency, and then the support currency is transmitted to the communication terminal 100 (P4). When the payment in the basic currency is included, settlement in the basic currency is executed as well.

FIG. 10 is a screen diagram of the support currency selection screen 202 on the communication terminal 100.

When the support currency button 194 of the payment screen 198 is touched (see FIG. 9), the output section 140 of the communication terminal 100 (P1) displays the support currency selection screen 202. In the support currency selection screen 202, a selection button 206 indicating the support currency owned by the user (P1) and the owned amount is displayed. According to FIG. 10, the user (P1) owns 520 (pts) of a support currency (K2<Shibuya>) issued in Shibuya, 11,000 (pts) of a support currency (K5<Osaka>) issued in Osaka, 18,453 (pts) of the support currency (K1<Odawara>) issued in Odawara, and 130 (Pts) of the support currency (K4<Nikko>) issued in Nikko.

Assume that the user (P4) is the shop in Odawara city and accepts the support currency (K1<Odawara>) and the support currency (K4<Nikko>) issued in Nikko city that associates with Odawara city. The communication terminal 100 (P4) notifies the communication terminal 100 (P1) of the acceptable types of the support currencies in the transaction. The output section 140 of the communication terminal 100 (P1) displays the selection buttons 206 of the unacceptable support currency (K2<Shibuya>) and support currency (K5<Osaka>) in a gray-out manner so as to set these buttons unselectable.

The user (P1) can use the support currency (K1<Odawara>) and the support currency (K4<Nikko>) at the shop (P4) in Odawara city. When the user (P1) selects the support currency (K1), the user (P1) determines the use amount (number of points). This also applies when the user (P1) selects the support currency (K4<Nikko>). When the user (P1) uses the support currency (K4<Nikko>) in Odawara city, the user (P1) is provided with a benefit. The support currency (K4<Nikko>) is set with a benefit condition that the benefit is provided “when used in Odawara city”. The output section 140 additionally displays a chance mark 208 on the selection button 206 of the support currency by which the user can receive the benefit.

The benefit condition of each of the support currencies is registered in the issuance server 110. Thus, when the user (P1) uses the support currency (K4<Nikko>), the benefit granting section 182 provides the benefit to the user (P1). The benefit is arbitrary, but may be a meal voucher (digital data) that can be used in Nikko, or the support currency (K4<Nikko>), for example.

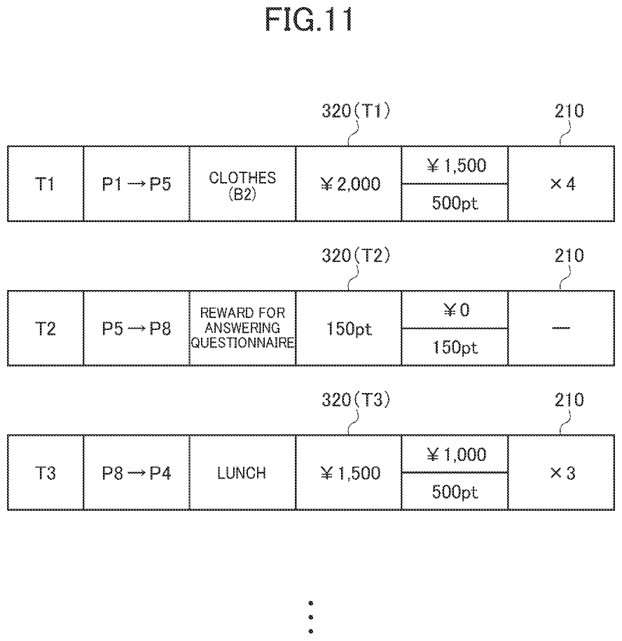

FIG. 11 is a data structure diagram of the transaction information 320.

The transaction management section 146 on the communication terminal 100 on a transmitting side generates the transaction ID when executing the transaction, and gives the transaction ID to the transaction information 320. The transaction ID is generated as a hash value including a time and unique information of the user ID. The transaction management section 146 may include information that can uniquely identify the transaction in the transaction information 320, such as a time when the transaction occurs, a location where the transaction occurs, or a user ID of a user involved in the transaction. Then, the transaction management section 146 may consider this information that can identify the transaction as the “transaction ID”. The transaction information 320 includes various types of information indicating details of the transaction such as a user ID of a transmitter (transferor), a user ID of a recipient (transferee), a product name (product code) of a transaction target, a product price, used amounts of the support currency and the basic currency, a transaction date and time, or a transaction reason.

For example, assume that the user (P1) pays 2,000 (yen) to a user (P5) for the price of “clothes (B2)”. Assume that the user (P1) pays 1, 500 (yen) out of 2, 000 (yen) in the basic currency, and pays 500 (pts) of the support currency (K1<Odawara>) equivalent to remaining 500 (yen). Assume that the transaction ID of this transaction is “T1”. In this case, the transaction management section 146 of the communication terminal 100 (P1) adds transaction information 320 (T1) to the 500 (pts) of the support currency (K1<Odawara>), in other words, to each of the 500 units of the support currency (K1<Odawara>). The communication terminal 100 (P1) transmits the 500 (pts) of the support currency (K1<Odawara>) to which the transaction information 320 (T1) is added to a communication terminal 100 (P5).

The transaction information 320 includes contribution degree data 210. In the transaction (T1), an economic transaction equivalent to 2,000 (yen) is made due to the 500 (pts) of the support currency. In this case, the transaction management section 146 calculates a circulation contribution degree of the support currency as “4 (=2,000/500)”. The circulation contribution degree indicates the transaction amount/the support currency, and indicates how much the support currency has moved the basic currency. In the case of the transaction (T1), the user (P1) has probably decided to purchase the clothes (B2) of 2, 000 (yen) because of a right to use the 500 (pts) of the support currency (K1<Odawara>).

Among the units of the support currency (K1<Odawara>) used in the transaction (T1), the support currency whose currency ID is C1 is expressed as a support currency (K1<Odawara>: C1), or a support currency (K1: C1). Here, assume that the support currency (K1: C1) is also used in a next transaction (T2). In the transaction (T2), the user (P5) pays 150 (pts) of the support currency (K1) to a user (P8) as a “reward for answering a questionnaire”. The transaction (T2) does not include the payment in the basic currency, and thus the circulation contribution degree is “0”. The transaction management section 146 of the communication terminal 100 (P5) adds transaction information 320 (T2) to the support currency (K1: C1).

Assume that the support currency (K1: C1) is also used in a next transaction (T3). In the transaction (T3), the user (P8) pays 1,500 (yen) to the user (P4) for lunch. The transaction (T3) includes the payment of 500 (pts) of the support currency (K1), and thus the circulation contribution degree is “3 (=1,500/500)”. The transaction management section 146 of a communication terminal 100 (P8) adds transaction information 320 (T3) to the support currency (K1: C1).

As described above, the transaction information 320 is added to the support currency every time the support currency is used in the transaction. Accordingly, it is possible to know a transaction history of each unit of the support currency by referring to the transaction information 320 of the support currency.

The support currency may be paid as wages such as salaries or part-time job fees. Alternatively, the support currency may be paid as a reward when a user registers as a member of a shop, visits a shop, or introduces a product on a social networking service (SNS).

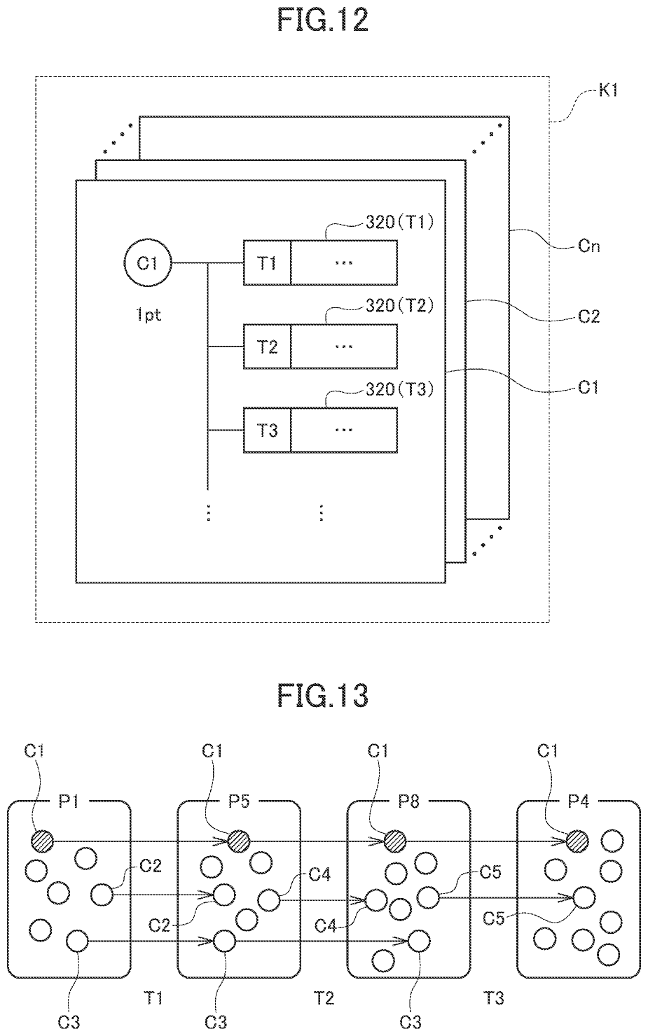

FIG. 12 is a data structure diagram of the transaction information 320 included in the support currency.

As described above, the plurality of types of the support currencies are identified by the type IDs. A group of the support currency (K1<Odawara>) includes a plurality of units of the support currency (K1<Odawara>). One unit of the support currency (K1) is 1 (pt) and is identified by the currency ID.

The support currency (K1: C1) whose currency ID is C1 is transferred among the communication terminals 100 due to the transactions among various users. The transaction information 320 is added by the communication terminal 100 on the transmitting side every time the transaction occurs. This also applies to units of the other support currency. In this way, one unit (pt) of the support currency includes one or more pieces of the transaction information 320. FIG. 12 shows the data structures of the support currency (K1<Odawara>: C1) to the support currency (K1<Odawara>: Cn). The data structures of the support currencies other than the support currency (K1<Odawara>) are similar to this.

FIG. 13 is a schematic diagram of a transfer state of the support currency.

In order to simplify the description, the transfer state of the support currency in the transactions among the users are shown schematically here. However, in actual transactions, the support currency is transferred complicatedly among a large number of users. In FIG. 13, the description is made assuming that part of the support currency owned by the user (P1) is transferred to the user (P5) (transaction (T1)), part of the support currency owned by the user (P5) is transferred to the user (P8) (transaction (T2)), and part of the support currency owned by the user (P8) is transferred to the user (P4) (transaction (T3)).

Firstly, in the transaction (T1), the part of the support currency owned by the user (P1) is transferred to the user (P5). Here, assume that the support currency (C1), the support currency (C2), and the support currency (C3) are transmitted. At this time, the transaction management section 146 of the communication terminal 100 (P1) gives the transaction information 320 (T1) to each of these three units of the support currency.

Next, in the transaction (T2), the part of the support currency owned by the user (P5) is transferred to the user (P8). Assume that the support currency (C1) and the support currency (C3) are transmitted, and the support currency (C4) that has been owned by the user (P8) all along is also transmitted. On the other hand, the support currency (C2) that the user (P8) has acquired in the transaction (T1) is not transferred.

When the transaction (T2) is completed, the transaction information 320 (T1) and the transaction information 320 (T2) have been added to the support currency (C1) and the support currency (C3). The latest transaction information 320 for the support currency (C2) is the transaction information 320 (T1), whereas the transaction information 320 (T2) is added to the support currency (C4).

In the transaction (T3), the part of the support currency owned by the user (P8) is transferred to the user (P4). The support currency (C1) and the support currency (C5) are transferred, but the support currency (C4) is not transferred. The communication terminal 100 (P8) adds the transaction information 320 (T3) to the support currency (C1) and the support currency (C5).

When the transaction (T3) is completed, the transaction information 320 (T1) to 320 (T3) have been added to the support currency (C1). The transaction information 320 (T1) has been added to the support currency (C2), and the transaction information 320 (T1) and the transaction information 320 (T2) have been added to the support currency (C3). The transaction information 320 (T2) has been added to the support currency (C4), and the transaction information 320 (T3) has been added to the support currency (C5).

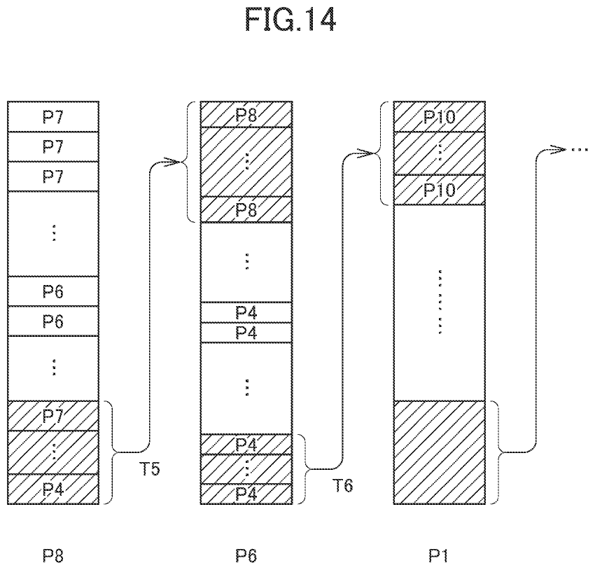

In actual operation, the units of the support currency to be transmitted are selected by a first-in, first-out (FIFO) method, and thus the units of the support currency are not selected as shown in FIG. 13. A method for selecting the units of the support currency to be transmitted from a large number of units of the support currency owned by the user is described in relation to next FIG. 14.

FIG. 14 is a schematic diagram of a method for selecting the units of the support currency to be transmitted.

The following describes a transaction (T5) in which the user (P8) pays the support currency (K1<Odawara>) to a user (P6) and a transaction (T6) in which the user (P6) pays the support currency (K1) to the user (P1).

The user (P8) owns a plurality of units of the support currency (K1) acquired from the user (P4), a user (P7), the user (P6), or the like. FIG. 14 shows the units of the support currency (K1) acquired lately on an upper side, and then, the lower the units of the support currency (K1) are listed, the earlier the units of the support currency (K1) have been acquired. In the transaction (T5), when the user (P8) pays a predetermined number of units of the support currency (K1) to the user (P6), the transaction management section 146 of the communication terminal 100 (P8) selects the predetermined number of units of the support currency (K1) in order from the unit of the support currency (K1) with an oldest acquisition date and time to transmit to the communication terminal 100 (P6). That is, the transaction management section 146 manages the support currency (K1) by the so-called FIFO method.

After the transaction (T5), the communication terminal 100 (P6) stores the support currency (K1) received from the user (P8) in the currency storage section 148 as owned currency. In the transaction (T6), the transaction management section 146 of the communication terminal 100 (P6) also selects the units of the support currency (K1) to be transmitted in order from the unit of the support currency (K1) with an oldest acquisition date and time.

Selecting the units of the support currency (K1) to be transmitted by the FIFO method prevents that part of the support currency (K1) stays long in the currency storage section 148 of a particular user. If only part of the support currency (K1) become the transaction target, a large number of pieces of the transaction information 320 are given only to the part of the support currency (K1). Adopting the FIFO method makes it easier to equalize the numbers of pieces of the transaction information 320 included in the large number of units of the support currency (K1), that is, data sizes of the respective units of the support currency (K1).

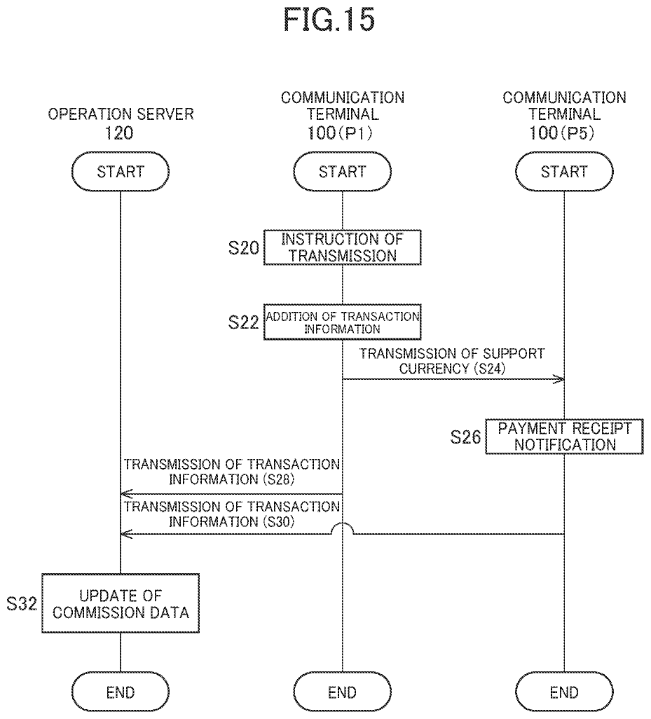

FIG. 15 is a sequence diagram illustrating a transaction process using the support currency.

Here, the description is made assuming that the user (P1) pays the support currency to the user (P5) in the transaction (T1). Firstly, the user (P1) instructs transmission (payment) of the support currency to the user (P5) on the payment screen 198 (S20). The transaction management section 146 of the communication terminal 100 (P1) adds the transaction information 320 (T1) to the support currency to be transmitted (S22).

The transmission section 142 of the communication terminal 100 (P1) transmits the support currency to the communication terminal 100 (P5), and the reception section 144 of the communication terminal 100 (P5) receives the support currency (S24). As described above, the support currency is transmitted in the encrypted state. The transaction management section 146 of the communication terminal 100 (P5) determines that the support currency is authentic if the transaction management section 146 can decrypt the support currency. The support tool installed on the communication terminal 100 has a common secret key. Encryption and decryption are executed using this common key.

The output section 140 of the communication terminal 100 (P5) on the receiving side displays a payment receipt notification if the authenticity of the support currency is confirmed (S26). As described above, transmission of the basic currency may be executed along with transmission of the support currency.

The transaction management section 146 of the communication terminal 100 (P1) also transmits the transaction information 320 indicating a transaction result to the operation server 120 via the transmission section 142 (S28). Similarly, the communication terminal 100 (P5) also transmits the transaction information 320 indicating the transaction result to the operation server 120 (S30). The commission collection section 160 of the operation server 120 compares the two pieces of the transaction information 320, and updates accumulated commission information 220 of the user (P5) on the receiving side of the support currency (S32). The accumulated commission information 220 is information recording an accumulated unpaid amount of the commissions of each user (described later).

When the operation server 120 has verified the transaction information 320, the transmission section 156 of the operation server 120 may transmit a transaction approval notification to both or one of the communication terminal 100 (P1) and the communication terminal 100 (P5). Upon receipt of the transaction approval notification, the transaction management section 146 of the communication terminal 100 (P5) on the receiving side of the support currency may additionally record the transaction approval in the transaction information 320 of the support currency received at S24.

The transaction approval by the operation server 120 may not be executed. In this case, only either of the communication terminal 100 (P1) or the communication terminal 100 (P5) may notify the operation server 120 of the transaction information 320.

The commission is determined to be a predetermined percentage of the support currency paid in the transaction. For example, when the commission rate is 1(%), and the support currency used in the transaction is 1,000 (pts), the operation server 120 collects 10 (yen) corresponding to 1 (%) of the transaction amount as the commission. The commission is collected from the user on the receiving side of the support currency in the present embodiment. However, the commission may be collected from the user on the paying side. Although the commission may be collected every time the transaction occurs, the commission is collected in a lump sum once a month at the end of the month in the present embodiment.

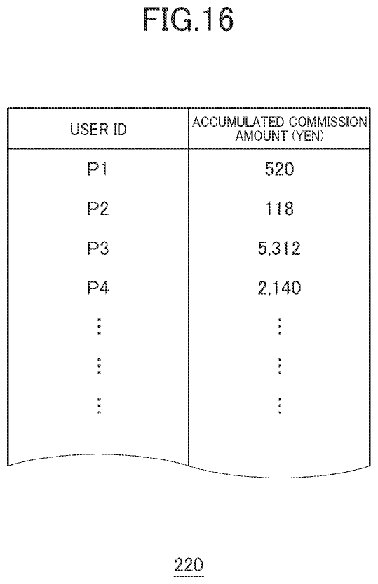

FIG. 16 is a data structure diagram of the accumulated commission information 220.

The accumulated commission information 220 is stored in the data storage section 154 of the operation server 120. The accumulated commission information 220 indicates an accumulated unsettled commission amount of each user. The commission collection section 160 records an amount equivalent to the part of the support currency in the accumulated commission information 220 as the commission every time the transaction occurs between the users. For example, when the user (P1) pays the support currency to the user (P5), the commission collection section 160 adds the commission on the new transaction to the accumulated commission amount of the user (P5).

The commission collection section 160 instructs the settlement system 104 to withdraw the unpaid commission from the bank account of each user at the end of the month. The commission collection section 160 updates the accumulated commission information 220 after the settlement. The accumulated commission information 220 records only the unpaid commission.

For example, the accumulated commission amount of the user (P1) is 520 (yen), and the commission collection section 160 withdraws 520 (yen) in the basic currency (legal currency) from the bank account of the user (P1) at the end of the month. After withdrawal, the accumulated commission amount of the user (P1) in the accumulated commission information 220, that is, the unpaid amount becomes 0 (yen).

The commission collection section 160 may share the accumulated commission information 220 with the settlement system 104, and instruct the Internet 102 to prevent that a bank balance becomes less than the accumulated commission amount.

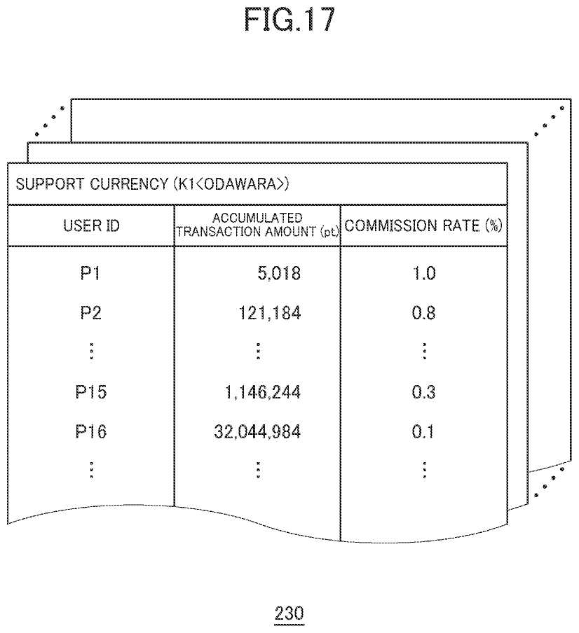

FIG. 17 is a data structure diagram of commission setting information 230.

The commission setting information 230 is stored in the data storage section 154 of the operation server 120. The commission setting information 230 indicates an accumulated transaction amount and a commission rate of each user in relation to the support currency (K1<Odawara>). The aggregation section 164 of the operation server 120 updates the accumulated transaction amount of the user on the paying side of the support currency (K1) every time the transaction occurs. According to the commission setting information 230 in FIG. 17, the user (P1) has used a total of 5,018 (pts) of the support currency (K1). The accumulated transaction amount indicates a sum (pt) of the support currency transmitted within a predetermined period.

The commission collection section 160 sets the commission rate depending on the accumulated transaction amount. A base commission rate is 1.0 (%). When the accumulated transaction amount exceeds 100,000 (pts), the commission collection section 160 reduces the commission rate to 0.8 (%). Since the accumulated transaction amount of the user (P2) is 121,184 (pts), the commission collection section 160 sets the commission rate of the user (P2) to 0.8 (%). That is, when the user (P2) receives the support currency from another user, the user (P2) pays the basic currency equivalent to 0.8 (%) of the received support currency to the operation company as the commission.

By reducing the commission to pay when the user receives the support currency as the user uses the support currency more actively, motivation to use the support currency can be enhanced. In addition, since the basic currency is also often used when the support currency is used, activating the circulation of the support currency can activate the circulation of the basic currency.

When the accumulated transaction amount exceeds 1 million (pts), the commission collection section 160 changes the commission rate to 0.3 (%). When the accumulated transaction amount exceeds 10 million (pts), the commission collection section 160 changes the commission rate to 0.1 (%).

The commission collection section 160 may set the commission rate based on the attribute information of the user. For example, the commission collection section 160 may change the commission rate depending on whether the user is an individual or a business entity, or a large company or a small-to-medium-sized company. The commission collection section 160 may set the commission rate depending on gender, age, a place of residence, household income, or the like.

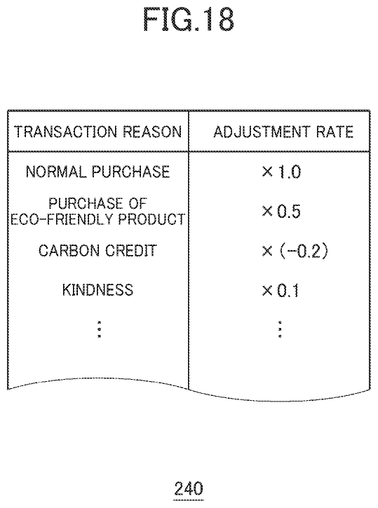

FIG. 18 is a data structure diagram of commission adjustment information 240.

The commission adjustment information 240 is stored in the data storage section 154 of the operation server 120. The commission adjustment information 240 indicates an adjustment rate of the commission depending on the transaction reason. The commission collection section 160 changes the commission depending on the transaction reason to promote particular transactions. The adjustment rate is “×1.0” for purchase of a normal product. Since the commission rate of the user (P1) is 1.0 (%) (see FIG. 17), when another user purchases a normal product from the user (P1), the commission rate applied in relation to the commission to be paid by the user (P1) is 1.0 (%) (=1×1).

The local government may specify an “eco-friendly product (environmentally conscious product)” out of a large number of products. The adjustment rate of the eco-friendly product is “x 0.5”. When another user purchases an eco-friendly product from the user (P1), the commission rate to be applied to the user (P1) becomes 0.5 (%) (=1×0.5). Such adjustment can enhance motivation of the user (P1) to sell the eco-friendly product.

The adjustment rate of a carbon credit is “×(−0.2)”. Assume that the user (P1) is a producer of the carbon credits. In this case, when another user purchases the carbon credit from the user (P1), the commission rate applied to the user (P1) is −0.2 (%) (=1×(−0.2)). That is, when the carbon credit is sold, the operation company pays the basic currency to the user (P1).

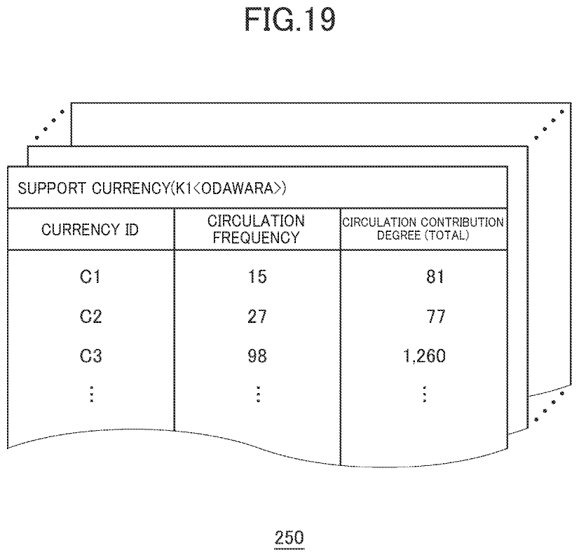

FIG. 19 is a data structure diagram of currency circulation information 250.

The currency circulation information 250 is stored in the data storage section 154 of the operation server 120. The currency circulation information 250 indicates a number of circulations (a number of transactions) and a total circulation contribution degree of the support currency (K1<Odawara>). The operation company collects the support currency from a goods market through the exchange requests (see FIG. 1) from the users. The aggregation section 164 confirms the transaction information 320 of the collected support currency and calculates the number of circulations and the circulation contribution degree.

The currency circulation information 250 in FIG. 19 is an aggregation of data of the support currency (K1<Odawara>). The support currency (K1: C1) is used for 15 transactions since it is issued by the operation company until it is collected by the operation company. In other words, the support currency (K1: C1) is given 15 pieces of the transaction information 320. On the other hand, the number of circulations of the support currency (K1: C3) is 98. Accordingly, it is understood that the support currency (K1: C3) is used for more transactions than the support currency (K1: C1).

The aggregation section 164 calculates a total value of the circulation contribution degree for each unit of the support currency. In particular, the aggregation section 164 sums up the circulation contribution degrees included as the contribution degree data 210 in the plurality of pieces of the transaction information 320 added to the support currency (K1: C1), and records the total value in the currency circulation information 250. The total value of the circulation contribution degree of the support currency (K1: C1) is “81”. This means that the circulation of the 1 (pt) of the support currency (K1: C1) has caused the circulation of 81 (yen) of the basic currency. In other words, the total value “81” of the circulation contribution degree indicates a magnitude of economic effects by the support currency (K1: C1).

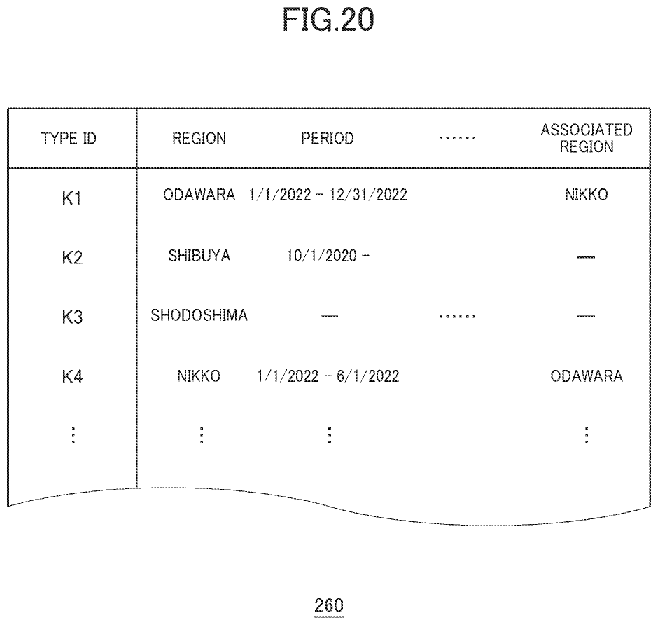

FIG. 20 is a data structure diagram of use condition information 260.

The use condition information 260 is stored in the data storage section 154 of the operation server 120. The use condition information 260 indicates the use condition of the support currency. The local government sets the use condition for the operation company when issuing the support currency.

The support currency (K1) is set to be valid in Odawara city. In particular, the support currency (K1<Odawara>) can be used by the users who are registered residents in Odawara city and at the shops whose main shops or branch shops are set to Odawara city. The transaction using the support currency (K1) is allowed on condition that the recipient of the support currency (K1) is the user in Odawara city. Odawara city associates with Nikko city that is a sister city. Accordingly, the support currency (K1<Odawara>) can be used not only in Odawara city, but also in Nikko city.

A valid period of the support currency (K1<Odawara>) is for one year from “Jan. 1, 2022” to “Dec. 31, 2022”. Thus, the support currency (K1) cannot be used in 2023. The user who still owns the support currency (K1) in 2023 requests the operation server 120 to exchange the support currency into the basic currency. The currency exchange section 180 of the operation server 120 receives the support currency from the user and pays the basic currency to the user. Alternatively, the currency exchange section 180 may invalidate the support currency (K1) circulating in the market after the valid period ends. The invalidated support currency (K1) cannot be exchanged by the operation server 120.

The support currency (K4<Nikko>) of Nikko city can also be used in Odawara city. As described above, when the support currency (K4<Nikko>) is used in Odawara city, the benefit granting section 182 provides the benefit to the user. Alternatively, the benefit granting section 182 also provides the benefit to the user when the support currency (K1<Odawara>) is used in Nikko city.

The local government can arbitrarily set the use condition. For example, the use condition may restrict usage, such as restricting the shops that can accept the support currency, the products that can be dealt with using the support currency, or the days of the week when the support currency can be used. In addition, the use condition may quadruple the circulation contribution degrees or more for the transactions using the support currency, or the use condition may relate to weather, such as allowing use of the support currency only on rainy days. Alternatively, a benefit condition may be set, such as providing a benefit on rainy days.

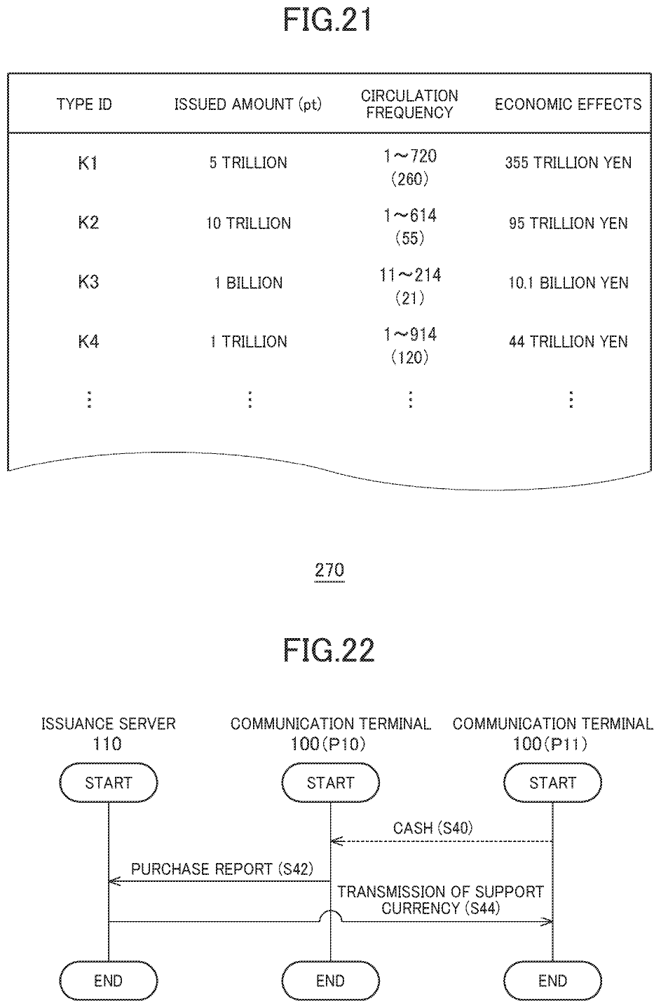

FIG. 21 is a data structure diagram of economic effect information 270.

The economic effect information 270 is stored in the data storage section 154 of the operation server 120. The economic effect information 270 indicates economic effects of the various types of the support currencies. After the valid period of each of the support currencies ends, the aggregation section 164 refers to the currency circulation information 250, and calculates the economic effects of the support currency.

The support currency (K1<Odawara>) includes 5 trillion (pts) issued. A minimum value of the number of circulations of the support currency (K1<Odawara>) is one (time), a maximum value is 720 (times), and an average value is 260 (times). If the average value of the circulation contribution degree of the support currency (K1<Odawara>) is 71 (times), the circulation amount of the basic currency due to the support currency (K1) can be calculated to be 355 trillion (yen) (=5 trillion×71). Instead of the average value, a median value or a mode value may be adopted as a representative value of the distribution of the number of circulations.

Referring to the use condition information 260 and the economic effect information 270 enables consideration of a relationship between the use condition of the support currency and the economic effects. For example, when a result tells that the economic effects by the support currency (K1<Odawara>) is large, similar economic effects can be expected by independently issuing the support currency with the same use condition as that of the support currency (K1) in other regions. In other words, an experience of the local government of Odawara city can be utilized in other regions.

### <Summary>

The support currency management system 200 has been described above based on the embodiment.

The users are provided with the support currency for free from the local government, and can use the support currency similarly to the normal basic currency. Since a resource of the support currency is borne by the local government, the users can easily use the support currency without any economic burden. Then, circulation of the basic currency along with the support currency vitalizes the economic activities.

Adding various use conditions or benefit conditions to the support currency gives the support currency individuality and originality. For example, in order to vitalize the economy in the region Z, a valid range of the support currency may be limited to the region Z. Moreover, when a valid period is set to the support currency so that the support currency becomes invalid after the valid period ends, it is possible to motivate the users to use the support currency while it is valid. This makes it easier to increase the number of circulations of the support currency.

If the support currency is distributed to the users who visit the region Z, it becomes easier to motivate people to visit the region Z. Since the visitors to the region Z are assumed to use the basic currency along with the support currency in the region Z, money (basic currency) can be brought into the region Z from outside.

The support currency may be distributed for free only to a young generation having strong buying intensions or a generation raising children, or the support currency that can be used only for education may be issued. In this way, the local government can distinctively contrive the distribution targets and the use conditions of the support currency in line with policy objectives.

The local government pays the basic currency (money) to the operation company to have the support currency issued. Accordingly, the local government bears the funding of the support currency. On the other hand, if the economy is vitalized through the support currency, the local government can expect an increase in tax revenues by corporation tax or consumption tax.

The support currency owned by the users on the communication terminals 100 is managed by the FIFO method. This allows control to prevent that only the part of the support currency becomes the transaction target.

Although the support currency is circulated similarly to the basic currency, the support currency is set with the use condition. The more a purpose and a method of use are restricted by the use conditions, the more the support currency becomes “something like the currency, but not the currency”. Thus, it becomes easier for both the transferor and the transferee to reduce psychological resistance when the support currency is paid as the reward for the kindness or favor received from someone than when the basic currency of the legal currency is paid. Especially, since the support currency is originally distributed for free, the users can casually pay the support currency as the reward for the kindness.

The transaction information 320 is added to the support currency every time the transaction occurs. Confirming the transaction information 320 added to the support currency enables detail analyzation of how much the support currency has been used, what it has been used for, and how much economic effects it has exerted.

For example, if it is found that the support currency issued by a certain local government has exerted the economic effects, it is easier for other local governments to introduce similar policies. Moreover, even if the economic effects of the support currency issued by the certain local government are small, sharing a failure experience can prevent other local governments from making the same mistake. When the support currency issued by the certain local government has exerted the economic effects, the national government may issue the support currency with the similar use condition. Since the support currency management system 200 can measure the economic effects by the support currency, making a rational economic policy becomes easier.

The operation company collects the commission every time the transaction occurs. This commission becomes operation funds for the operation company. By reducing the commission rate as the user uses the support currency more, it becomes easier to further evoke the motivation to use the support currency. Even if the commission rate is reduced, if the number of transactions using the support currency increases, the operation company can secure sufficient profit earning opportunities.

By changing the commission rate depending on the attribute information of the user who makes the transaction or the transaction reason, the transaction can be controlled to some extent. For example, by reducing the commission rate when the users purchase products related to fuel cell vehicles (FCVs), the spread of the FCVs may be promoted.

It is possible to provide pleasure to the users to collect various types of the support currencies. The users may collect the support currencies as unique money from all over Japan or countries all over the world so as to make a collection of the support currencies. The support currency may set with a uniquely designed image. The users can enjoy the collection more by arranging and displaying the various support currencies with different designs on the support currency selection screen 202. Alternatively, an application software dedicated to listing and displaying the collection of the support currencies may be provided. Evoking collection demands can increase values of the support currencies.

The present disclosure is not limited to the embodiment described above or modified examples, and may be implemented by modifying components without departing from the scope of the present disclosure. A plurality of components disclosed in the embodiment described above or the modified examples may be combined as appropriate to form various inventions. In addition, some of the components may be deleted from the entire components indicated in the embodiment described above or the modified examples.

The support currency management system 200 has been described to include the plurality of communication terminals 100, the issuance server 110, and the operation server 120. However, some of the functions of the communication terminals 100 may be implemented by the issuance server 110 or the operation server 120, and some of the functions of the issuance server 110 or the operation server 120 may be assigned to the communication terminals 100. Moreover, another device except for the communication terminals 100, the issuance server 110, and the operation server 120 may perform some of the functions of the communication terminals 100, the issuance server 110, or the operation server 120. Broadly speaking, an aggregation of the functions of the communication terminals 100, the issuance server 110, and the operation server 120 can be considered as one “information processing apparatus”. How to allocate a plurality of functions required for implementing the present disclosure to one or more pieces of hardware may be determined in view of processing capacity of each piece of the hardware, specifications required for the support currency management system 200, or the like.

### Modified Examples

In the present embodiment, it has been described that the DI engine (support tool) including the communication function is installed on the communication terminal 100. The DI engine may be implemented by an IC chip and an application software, only by an application software, or only by a dedicated electronic circuit such as an IC chip.

FIG. 22 is a sequence diagram illustrating a processing process of distributing the support currency as an expression of gratitude for purchasing a product according to a modified example.

When a user purchases a product at a shop, the shop may give the support currency to the purchaser as an expression of gratitude. In the modified example shown in FIG. 22, the local government pays the basic currency to the operation company to have the support currency issued. It is assumed that the operation company manages the basic currency, and the local government manages the support currency.

Firstly, assume that a user (P11) that is an individual purchases a product from a user (P10) that is a shop. Assume that the user (P10) is a “designated shop” designated by the local government. The designated shop may be selected arbitrarily, but may be a small shop in a region that the local government wants to support, for example. The user (P11) pays the price of the product in the basic currency (cash) to the user (P10: designated shop) (S40). The user (P10) reports the purchase of the product in the basic currency to the local government (issuance server 110) (S42). In particular, the transaction management section 146 of a communication terminal 100 (P10) notifies the issuance server 110 of the user ID of the purchaser which is P11, the user ID of the seller which is P10, and a payment amount for the product.

The distribution section 108 or the benefit granting section 182 of the issuance server 110 confirms that the user ID of the seller matches the user ID of the designated shop, and transmits the support currency corresponding to part of the payment amount such as 0.5 (%) to the user (P11: purchaser) (S44). At this time, the operation company may collect the commission in relation to the part of the support currency.

With such a control method, the user who purchases the product at the designated shop can receive the support currency, so that purchasing behavior at the designated shop can be promoted. The local government can support the designated shop through the support currency. In addition, by distributing the support currency to the user who purchases the product at the designated shop, the support currency can be gradually circulated in the region.

Instead of limiting to the designated shop, the support currency may be distributed with a designated product as a target. For example, when a designated product such as an electric vehicle (EV) is purchased, the issuance server 110 may distribute the support currency to the purchaser. Alternatively, when a recycling fee for oversized trash is paid, the issuance server 110 may distribute the support currency to the payer to promote recycling.

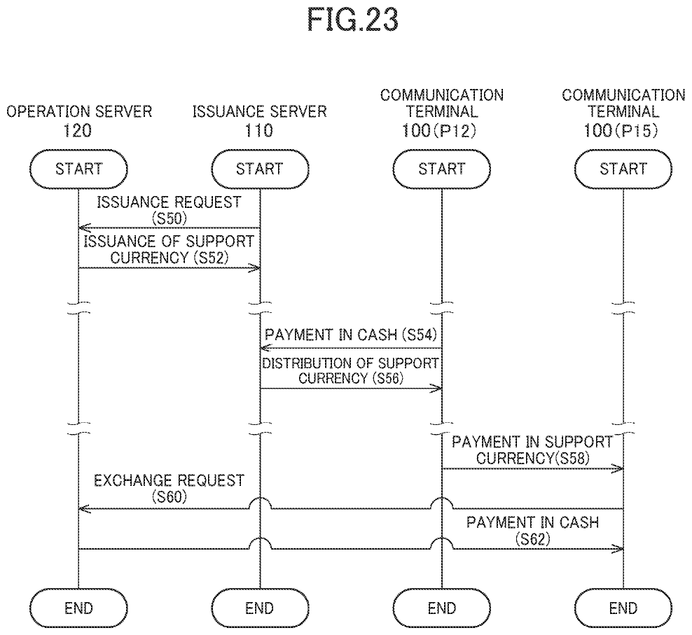

FIG. 23 is a sequence diagram illustrating a processing process of purchasing the support currency for a fee according to a modified example.

In the present embodiment, the description has been made assuming that the local government instructs the operation company to issue the support currency for a fee, and distributes the support currency to the users for free. As a modified example, the users may purchase the support currency in the basic currency from the local government. In the modified example shown in FIG. 23, the local government pays the basic currency to the operation company to have the support currency issued. It is assumed that the operation company manages the basic currency, and the local government manages the support currency. Moreover, assume that not only the operation server 120, but also the issuance server 110 includes a currency exchange section (not illustrated) for a case that a user (P12) pays the support currency to a user (P15).

Firstly, the local government (issuance server 110) requests the operation company (operation server 120) to issue the support currency (S50). The operation server 120 receives a deposit in the basic currency (cash) corresponding to the support currency from the local government, and issues the support currency (S52). The local government owns the support currency as the issued deposit currency.

Here, assume that the user (P12) wants to purchase the support currency. The user (P12) requests the issuance server 110 for purchase of the support currency. At this time, the user (P12) pays the basic currency (cash) to the issuance server 110 (S54). The currency exchange section of the issuance server 110 transmits the support currency to a communication terminal 100 (P12) (S56). The basic currency and the support currency may be exchanged equivalently, or may be exchanged at an exchange rate advantageous to the user (P12). For example, the user may purchase 100,000 (pts) of the support currency by paying 80,000 (yen). The currency exchange section of the issuance server 110 instructs the settlement system 104 to withdraw a price of the support currency from a bank account of the user (P12) in the basic currency.

Next, a transaction occurs between the user (P12) and the user (P15), and the user (P12) pays the support currency to the user (P15) (S58). The user (P15) can request the operation server 120 to exchange the received support currency into the basic currency. The communication terminal 100 (P15) transmits an exchange request including the support currency to the operation server 120 (S60). The currency exchange section 180 of the operation server 120 exchanges the support currency into the basic currency. At this time, 1 (pt) of the support currency is exchanged into 1 (yen) of the basic currency. The currency exchange section 180 provides the basic currency to a communication terminal 100 (P15) (S62). The basic currency may be paid as electronic money, or may be transferred to a bank account of the user (P15) via the settlement system 104.

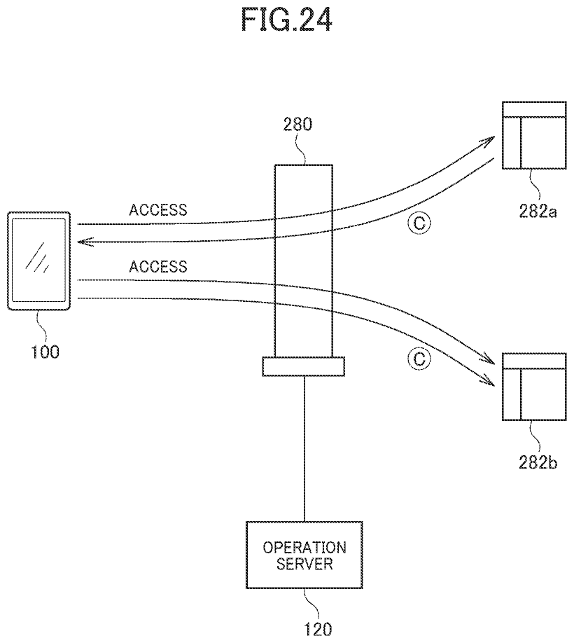

FIG. 24 is a conceptual diagram illustrating a method for circulating the support currency through website access according to a modified example.

A user accesses a website 282a, 282b, or the like from the communication terminal 100 through a charging server 280. The charging server 280 notifies the operation server 120 of access information when an access is made. The access information includes the user ID of the user who has accessed the website 282a, a user ID of an operator of the website 282a, a uniform resource identifier (URI) of the website 282a, or the like. The operation server 120 is set with a payment condition that the site operator of the website 282a pays the support currency to the users who access the website 282a.

The site operator (website 282a) can increase a number of accesses to the website 282a by paying the support currency to visitors to the website 282a. The payment condition may be that the support currency is paid only for a first access, or that the support currency is paid only for accesses within a predetermined period.

The charging server 280 transmits the access information to the operation server 120 when the access to the website 282a is made. The settlement management section 162 of the operation server 120 refers to the payment condition of the website 282a, notifies an address of the user to a communication terminal 100 of the site operator, and instructs transmission of the support currency to the communication terminal 100 of the user who has visited the website.

On the other hand, when the user accesses the website 282b, the user pays the support currency to a site operator of the website 282b. For example, the website 282b provides paid video content, and the user pays the support currency to the site operator as a payment for viewing. The charging server 280 notifies the user ID of the user who has accessed the website 282b, the user ID of the site operator, or the like to the operation server 120 when the access to the website 282b is made. The operation server 120 refers to the payment condition of the website 282b, and instructs the user to transmit the support currency to the site operator.

Moreover, an advertiser of an Internet advertisement may pay the support currency to users who view the advertisement. Alternatively, a user may transmit the support currency to the site operator beforehand, and the site operator may confirm receipt of the support currency and then transmit a web page to this user. The operation server 120 collects the commission when the payment of the support currency occurs due to viewing the web page.

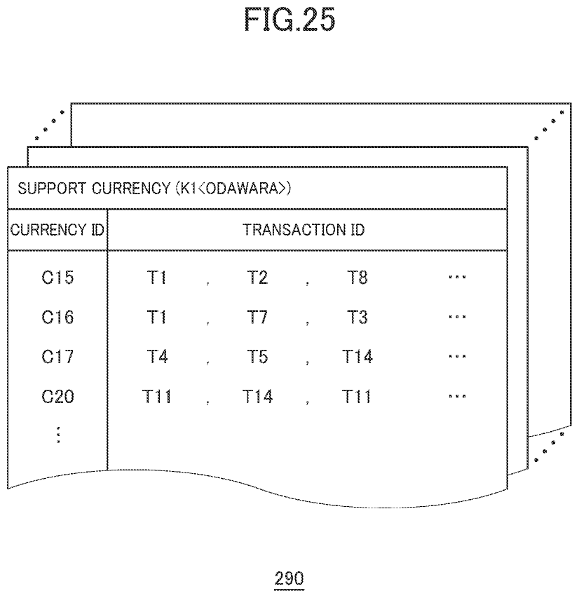

FIG. 25 is a data structure diagram of transaction history information 290 according to a modified example.

In the present embodiment, it has been described that the transaction information 320 is attached to the support currency and transmitted/received between the communication terminals 100 with the support currency. As a modified example, the transaction information 320 may be managed at the operation server 120. The transaction history information 290 is stored in the data storage section 154 of the operation server 120. The transaction history information 290 in FIG. 25 indicates transaction results of the support currency (K1<Odawara>).

When the communication terminal 100 (P1) transmits a support currency (K1: C15) and a support currency (K1: C16) to the communication terminal 100 (P2) in the transaction (T1), the communication terminal 100 (P1) transmits the transaction ID which is T1, the currency ID, and the transaction information 320 to the operation server 120. The communication terminal 100 (P2) also transmits similar information to the operation server 120. A transaction registration section (not illustrated) of the operation server 120 updates the transaction history information 290 to record the transaction ID of T1 in association with the support currency (K1: C15) and the support currency (K1: C16). The transaction registration section also records the transaction information 320 with the transaction ID in the data storage section 154. In this modified example, only data of the support currency is transmitted from the communication terminal 100 (P1) to the communication terminal 100 (P2), and the transaction information 320 is not transmitted.

When the communication terminal 100 (P2) transmits the support currency (K1: C15) to the communication terminal 100 (P3) in the transaction (T2), the communication terminal 100 (P2) and the communication terminal 100 (P3) transmit the transaction ID which is T2, and the currency ID which is C15, and the transaction information 320 to the operation server 120. The transaction registration section of the operation server 120 records the transaction ID of T2 in association with the support currency (K1: C15), and records the transaction information 320 (T2) in the data storage section 154.

With such a control method, the operation server 120 records the transaction result in the transaction history information 290 each time the transaction occurs, so that the operation server 120 can assess the circulation state of the support currency in real time by referring to the transaction history information 290.

Even if the local public organization has equally distributed the support currency for free to the shops in the region, amounts of the support currency owned by the shops may become unbalanced depending on sales of the shops. For example, assume that a shop Q1 owns 10,000 (pts) of the support currency, and a shop Q2 owns 150,000 (pts) of the support currency. At this time, the shop Q1 may be able to purchase the support currency from the shop Q2. In particular, the shop Q1 transmits a purchase request for purchasing 50,000 (pts) of the support currency at 1.2 (yen) per point to the operation server 120. The currency exchange section 180 notifies the shop Q2 of the request from the Q1. When the shop Q2 agrees, the currency exchange section 180 purchases 50,000 (pts) of the support currency from the shop Q2, and sells the purchased support currency to the shop Q1. With such a control method, imbalance in the amounts of the support currency between the shops can be adjusted as appropriate.

The exchange rate between the basic currency and the support currency may be fixed or variable. If the need for the support currency increases, the value of the support currency increases. On the contrary, if the basic currency is preferred to the support currency due to restrictions imposed by the use conditions, the value of the support currency may decrease relatively. The currency exchange section 180 of the operation server 120 may change the exchange rate of the support currency based on a predetermined calculation formula that uses the number of circulations and the circulation contribution degree of the support currency as variables.

The operation server 120 may exchange the support currency and the basic currency by receiving a first exchange request from the support currency to the basic currency and a second exchange request from the basic currency to the support currency, and matching these two exchange requests. At this time, the currency exchange section 180 of the operation server 120 may present the exchange rate and change the exchange rate depending on which of the first exchange request and the second exchange request is stronger. Moreover, when the issuance section 166 additionally issues the support currency in response to the request from the local government, an amount of the support currency to be issued may be determined depending on the exchange rate at that time.

The support currency in the present embodiment has been described as the regional currency that is valid only in a specific region. The support currency may be currency that is issued by the Japanese government and valid throughout Japan. Alternatively, the support currency may be valid in a plurality of countries.

The commission on the transaction of the support currency may be paid in the basic currency or the support currency. For example, when the user (P1) pays 500 (pts) of the support currency to the user (P2), the operation server 120 may collect 5 (pts) of the support currency from the user (P2). More particularly, when the user (P1) transmits the support currency to the user (P2), the transaction management section 146 of the communication terminal 100 (P2) instructs the transmission section 142 to transmit 5 (pts) of the support currency, which is 1 (%) of the transmitted support currency, to the operation server 120. With such a control method, the operation company can gradually collect the support currency from the goods market as the commission after issuing the support currency.

It can be said that users who use a large amount of the support currency make a large contribution to the economic activities. In addition, users who use a large amount of the basic currency along with the use of the support currency pay a large amount of consumption tax. Thus, the local government may provide preferential tax treatment to such users, such as reducing resident tax.

In the present embodiment, it has been described that the commission collection section 160 collects the commission from the user on the receiving side of the support currency. The commission collection section 160 may collect the commission from the user on the paying side of the support currency, or the users on both the transferor side and the transferee side.

The support currency may include a designated unit of the support currency at a rate of 1 (pt) per 100 (pts), for example. When a user transmits the designated unit of the support currency to the issuance server 110, the benefit granting section 182 of the issuance server 110 may provide a benefit to the user. With such a control method, it is possible to provide the user with pleasure to expect inclusion of the designated unit of the support currency when receiving the support currency. In addition, the user may give the designated unit of the support currency to express his/her gratitude to another user.

In the present embodiment, it has been described that when the support currency that is valid in a first region (Nikko city) is used in a second region (Odawara city), the benefit condition is met, and the benefit is provided to the user who has used the support currency. As a modified example, the benefit may be provided to the user who has received the support currency as well as the user who has used the support currency. Alternatively, when the support currency (K4<Nikko>) is used in Odawara city, the benefit may be provided to the user who has received the support currency (K4).

The local government may distribute the support currency for free to groups that perform volunteer activities. The groups may distribute the support currency to participants in the volunteer activities such as cleaning parks. In this way, the support currency makes it easier to reward values that have not been subject to money such as kindness or social contribution activities.

The commission collection section 160 may periodically collect the commission instead of when the transaction using the support currency occurs. For example, the commission collection section 160 may collect 0.1 (%) of the support currency owned by users once a week as the commission. With such a control method, the support currency decreases over time, so that it is possible to encourage the users to actively use the support currency.

The issuance section 166 or the benefit granting section 182 may distribute the support currency for free to users who have used a predetermined amount or more of the support currency in a predetermined period of time. With such a control method as well, the use of the support currency can be promoted. Generally speaking, an environmental load is lower when travelling by train than by car or air plane. The issuance section 166 may distribute the support currency for free to users who have travelled by train so as to encourage environmentally conscious behavior. As described above, it is possible to encourage many users to behave in line with policy objectives by adjusting the commission rate or distributing the support currency for specific behavior.

The operation company (operation server 120) may directly distribute the support currency to the communication terminals 100 instead of the local government (issuance server 110). As an example, assume that the issuance server 110 transmits an issuance request to the operation server 120 to distribute 10 billion (pts) of the support currency to 50,000 users in 200,000 (pts) each. At this time, the transmission section 176 of the issuance server 110 notifies the operation server 120 of the addresses of the communication terminals 100 of distribution targets. The issuance section 166 of the operation server 120 may issue 200,000 (pts) of the support currency to each of the communication terminals 100 of the specified 50,000 users.

The address of the communication terminal 100 may be a known address such as an email address, or may be an unique address of the support tool (DI engine) installed on the communication terminal 100.

The data processing section 134 of the communication terminal 100 may include a proposal section (not illustrated) and a sales management section (not illustrated). For example, assume that the communication terminal 100 is a POS terminal. Assume that a user (P20) (shop) provides the support currency as a purchase benefit to users who have purchased a product M on Nov. 23, 2022 that is a first verification period. The sales management section records “purchase date: product name: sales amount” in an associated manner when the support currency is paid as the purchase benefit. The “sales amount” here means a total sales amount of the shop on the day of “Nov. 23, 2022”.

The sales management section also searches websites for related information (period attribute information) related to the purchase date of “Nov. 23, 2022”. For example, assume that the related information related to the purchase date found in searching includes “minimum temperature at 5° C. or below”, “snowfall”, “late autumn”, “holiday”, or “Tuesday”. In addition, the product M is associated with related information (product attribute information) beforehand, such as “warm product”, “food”, or “confectionery”. If the sales amount is large on the purchase date (first verification period), for example, if the sales amount increases by 20 (%) or more than an average sales amount, it may be because the purchase benefit using the support currency is provided for the product M.

The sales management section records, as a “verification day”, a day on which the purchase benefit is provided and the sales amount is equal to or higher than a threshold value, for example, 20 (%) or more increase over the average sales amount. It is possible to set up hypotheses about the verification day, such as, “Providing the purchase benefit for the warm product when the minimum temperature is 5° C. or below has increased the sales”, “Providing the purchase benefit for food on the snowy day has increased the sales”, or “Providing the purchase benefit for the warm product on the holiday has increased the sales”.

The proposal section proposes to the user (P20) that the user (P20) set the purchase benefit if a combination of the related information on the purchase date on the verification day and the related information on the product is established. For example, if it snows on Dec. 21, 2022 that is a second verification date, the proposal section displays information via the output section 140, such as, “Providing the purchase benefit for the confectionery may increase the sales” or “Providing the purchase benefit for the warm product may increase the sales”.

With such a control method described above, the user (P20) can easily reproduce a useful method for providing the purchase benefit that has happed to be found on another day in order to increase the sales of the shop. Accordingly, the user (P20) can receive management support services through the communication terminal 100 by participating in the support currency management system 200.

As a result, the following is a disclosure understood from the description of the embodiment and the modified examples.

A1. A support currency management method including a step that an issuance system transmits basic currency to an operation system,
a step that the operation system stores the basic currency received from the issuance system as operation deposit currency,
a step that the operation system transmits support currency corresponding to the operation deposit currency to the issuance system,
a step that the issuance system stores the support currency received from the operation system as issued deposit currency,
a step that a communication terminal of a first economic entity transmits the basic currency to the issuance system,
a step that the issuance system subtracts the support currency corresponding to the basic currency received from the communication terminal of the first economic entity from the issued deposit currency, and transfers the subtracted support currency to the first economic entity,
a step that the support currency is transferred from the first economic entity to a second economic entity due to a transaction between the first economic entity and the second economic entity,
a step that a communication terminal of the second economic entity transmits the support currency transferred from the first economic entity to the operation system, and
a step that the operation system subtracts the basic currency corresponding to the support currency received from the communication terminal of the second economic entity from the operation deposit currency, and transfers the subtracted basic currency to the second economic entity.

Although only some embodiments of the present disclosure have been described in detail above, those skilled in the art will readily appreciate that many modifications are possible in the embodiments without materially departing from the novel teachings and advantages of this disclosure. Accordingly, all such modifications are intended to be included within scope of this disclosure.

What is claimed is:

1. A support currency management system comprising at least one processor or circuit programed to:
record transaction information related to a transaction in association with support currency of digital currency that has been transferred, when the support currency is transferred from a first economic entity to a second economic entity due to the transaction between the first economic entity and the second economic entity; and
add the transaction information related to the transaction as the transaction information of the support currency each time the transaction using the support currency occurs.

2. The support currency management system as defined in claim 1, wherein the at least one processor or circuit is further programmed to:
perform data management of the support currency for each currency unit;
when the support currency is used in a first transaction, add first transaction information related to the first transaction to data of the each currency unit of the support currency used in the first transaction; and
when part of the support currency used in the first transaction is used in a second transaction after the first transaction, further add second transaction information related to the second transaction to the data of the each currency unit of the part of the support currency.

3. The support currency management system as defined in claim 2, wherein the at least one processor or circuit is further programmed to calculate a number of transactions for the each currency unit of the support currency based on the data of the each currency unit of the support currency.

4. The support currency management system as defined in claim 1, wherein the at least one processor or circuit is further programmed to collect a commission from both or one of the first economic entity and the second economic entity when the support currency is transferred from the first economic entity to the second economic entity.

5. The support currency management system as defined in claim 4, wherein the at least one processor or circuit is further programmed to change the commission depending on a transaction state of the transaction using the support currency.

6. The support currency management system as defined in claim 5, wherein the at least one processor or circuit is further programmed to include a reason of occurrence of the transaction in the transaction information added to the support currency each time the transaction using the support currency occurs, and change the commission depending on the reason.

7. The support currency management system as defined in claim 1, wherein the at least one processor or circuit is further programmed to include a circulation contribution degree indicating a use ratio between basic currency and the support currency transferred in the transaction in the transaction information added to the support currency each time the transaction using the support currency occurs.

8. The support currency management system as defined in claim 7, wherein the at least one processor or circuit is further programmed to perform data management of the support currency for each currency unit, and calculate the circulation contribution degree of the each currency unit of the support currency to calculate an economic effect by the support currency.

9. The support currency management system as defined in claim 1, wherein the at least one processor or circuit is further programmed to issue the support currency in association with a use condition of the support currency, and determine whether the transaction between the first economic entity and the second economic entity meets the use condition to determine whether to allow transfer of the support currency from the first economic entity to the second economic entity.

10. The support currency management system as defined in claim 9,
wherein the use condition is a condition of a valid region of the support currency, and
wherein the at least one processor or circuit is further programmed to provide a predetermined benefit to both or one of the first economic entity and the second economic entity when the support currency set with the use condition setting a first region as the valid region is used in a second region that has been associated with the first region beforehand.

11. The support currency management system as defined in claim 2, wherein the at least one processor or circuit is further programmed to calculate a use amount of the support currency for each of the economic entities based on the transaction information of the support currency.

12. The support currency management system as defined in claim 11, wherein the at least one processor or circuit is further programmed to collect a commission from both or one of the first economic entity and the second economic entity when the support currency is transferred from the first economic entity to the second economic entity, and change the commission depending on the use amount of both or one of the first economic entity and the second economic entity.

13. The support currency management system as defined in claim 1, wherein the at least one processor or circuit is further programmed to issue the support currency at a predetermined exchange rate advantageous to a third economic entity when a purchase request for purchasing the support currency in basic currency is received from the third economic entity.

14. The support currency management system as defined in claim 1, wherein the at least one processor or circuit is further programmed to provide the support currency to a fourth economic entity when basic currency is transferred from the fourth economic entity to a fifth economic entity due to a transaction between the fourth economic entity and the fifth economic entity.

15. The support currency management system as defined in claim 1, wherein the at least one processor or circuit is further programmed to:
manage a sales amount in a predetermined verification period at a shop;
perform control for proposing to an economic entity selling a product that the economic entity provide the support currency when the product is purchased;
record, in an associated manner, period attribute information associated with a first verification period, product attribute information associated with the product for which the support currency is provided in the first verification period, and a sales amount in the first verification period; and
when the sales amount in the first verification period is equal to or larger than a predetermined threshold value, propose providing the support currency for the product having the product attribute information in a second verification period in a future having the period attribute information associated with the first verification period.

16. A communication terminal comprising at least one processor or circuit programed to:
perform data management of support currency of digital currency for each currency unit;
record transaction information related to a transaction using the support currency in association with the support currency used in the transaction for the each currency unit; and
transmit the support currency pertaining to the transaction to a communication terminal of a transaction counterpart of the transaction to transfer the support currency in the transaction.

17. The communication terminal as defined in claim 16, wherein the at least one processor or circuit is further programmed to store the support currency received from other communication terminals in order of receipt, and transmit the support currency preferentially in order from the support currency having an oldest receipt date and time to the communication terminal of the transaction counterpart.

18. The communication terminal as defined in claim 16, wherein the at least one processor or circuit is further programmed to accept specification of a ratio between basic currency and the support currency in a payment amount in the transaction from a user, and transmit the basic currency and the support currency at the specified ratio to the communication terminal of the transaction counterpart.
